(19) United States
(12) Patent Application Publication
(10) Pub. No.: US 2025/0131284 A1
(43) Pub. Date: Apr. 24, 2025

(54) DRILLING EVENT REMEDIATION FRAMEWORK

(71) Applicant: Schlumberger Technology Corporation, Sugar Land, TX (US)

(72) Inventors: Valerian Guillot, Montpellier (FR); Arvind Sharma, Houston, TX (US); Mohamed Khalil Nafi, London (GB); Jing Wu, Houston, TX (US); Alexey Ruzhnikov, Al-Khobar (SA)

(21) Appl. No.: 18/916,824

(22) Filed: Oct. 16, 2024

Related U.S. Application Data
(60) Provisional application No. 63/591,297, filed on Oct. 18, 2023.

(51) Int. Cl. G06N 3/096; G06N 3/0455; G06N 3/0475

(52) U.S. Cl. CPC G06N 3/096; G06N 3/0455; G06N 3/0475

(57) ABSTRACT

A method may include receiving a description of an event occurring at a wellsite; extracting a failure mode from the description using a fine-tuned large language model (LLM); identifying a matching failure mode from historical data processed using the fine-tuned LLM, where the matching failure mode is associated with one or more remedial actions that successfully resolved the matching failure mode; and outputting the one or more remedial actions for implementation at the wellsite.

### RELATED APPLICATIONS

This application claims priority to and the benefit of a U.S. Provisional Application having Ser. No. 63/591,297, filed 18 Oct. 2023, which is incorporated by reference herein in its entirety.

### BACKGROUND

A reservoir may be a subsurface formation that may be characterized at least in part by its porosity and fluid permeability. As an example, a reservoir may be part of a basin such as a sedimentary basin. A basin may be a depression (e.g., caused by plate tectonic activity, subsidence, etc.) in which sediments accumulate. As an example, where hydrocarbon source rocks occur in combination with appropriate depth and duration of burial, a petroleum system may develop within a basin, which may form a reservoir that includes hydrocarbon fluids (e.g., oil, gas, etc.).

In oil and gas exploration, interpretation is a process that involves analysis of data to identify and locate various subsurface structures (e.g., horizons, faults, geobodies, etc.) in a geologic environment. Various types of structures (e.g., stratigraphic formations) may be indicative of hydrocarbon traps or flow channels, as may be associated with one or more reservoirs (e.g., fluid reservoirs). In the field of resource extraction, enhancements to interpretation may allow for construction of a more accurate model of a subsurface region, which, in turn, may improve characterization of the subsurface region for purposes of resource extraction. Characterization of one or more subsurface regions in a geologic environment may guide, for example, performance of one or more operations (e.g., field operations, etc.). As an example, a plan may depend on a model of a subsurface region where the plan may specify how a drilling operation may accurately construct a borehole according to a trajectory that penetrates a reservoir, etc., where fluid may be produced via the borehole (e.g., as a completed well, etc.). As an example, one or more workflows may be performed using one or more computational frameworks, systems, etc., for one or more of analysis, acquisition, model building, control, etc., for exploration, interpretation, drilling, injection, fracturing, production, etc.

### SUMMARY

A method may include receiving a description of an event occurring at a wellsite and extracting a failure mode from the description using a fine-tuned large language model (LLM). The method may also include identifying a matching failure mode from historical data processed using the fine-tuned LLM. The matching failure mode may be associated with one or more remedial actions that successfully resolved the matching failure mode. The method may further include outputting one or more remedial actions for implementation at the wellsite. Various other apparatuses, systems, methods, etc., are also disclosed.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

The following detailed description refers to the accompanying drawings. Wherever convenient Features and advantages of the described implementations may be more readily understood by reference to the following description taken in conjunction with the accompanying drawings.

FIG. 1 shows an example of a system;

FIG. 2 shows an example of a system;

FIG. 3 shows an example of a system;

FIG. 4 shows an example of a system;

FIG. 5 shows an example of an architecture;

FIG. 6 shows an example of a plot;

FIG. 7 shows an example of a descriptions;

FIG. 8 shows examples of descriptions;

FIG. 9 shows an example of a system;

FIG. 10 shows an example of a method and an example of a system; and

FIG. 11 shows an example of a system.

### DETAILED DESCRIPTION

This description is not to be taken in a limiting sense, but rather is made merely for the purpose of describing the general principles of the implementations. The scope of the described implementations should be ascertained with reference to the issued claims.

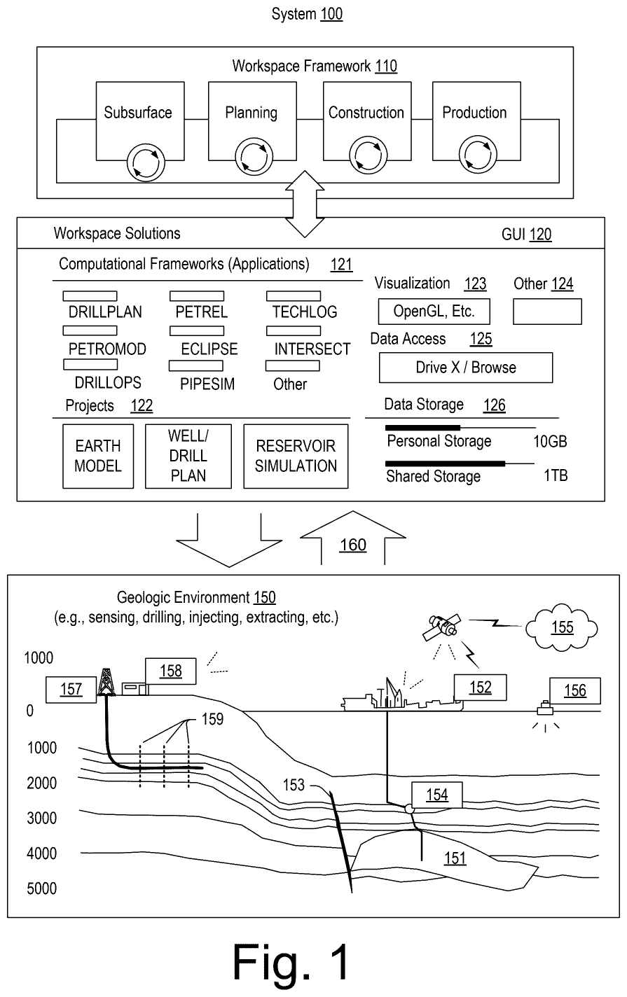

FIG. 1 shows an example of a system 100 that includes a workspace framework 110 that may provide for instantiation of, rendering of, interactions with, etc., a graphical user interface (GUI) 120. In the example of FIG. 1, the GUI 120 may include graphical controls for computational frameworks (e.g., applications, etc.) 121, projects 122, visualization features 123, one or more other features 124, data access 125, and data storage 126.

In the example of FIG. 1, the workspace framework 110 may be tailored to a particular geologic environment such as an example geologic environment 150. For example, the geologic environment 150 may include layers (e.g., stratification) that include a reservoir 151 and that may be intersected by a fault 153. As an example, the geologic environment 150 may be outfitted with a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a wellsite and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite in communication with the network 155 that may be configured for communications, noting that the satellite may additionally or alternatively include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

In the example of FIG. 1, the GUI 120 shows some examples of computational frameworks, including the DRILLPLAN, DRILLOPS, PETREL, TECHLOG, PETROMOD, ECLIPSE, PIPESIM, and INTERSECT frameworks (SLB, Houston, Texas).

The DRILLPLAN framework provides for digital well construction planning and includes features for automation of repetitive tasks and validation workflows, enabling improved quality drilling programs (e.g., digital drilling plans, etc.) to be produced quickly with assured coherency.

The DRILLOPS framework may execute a digital drilling plan and ensures plan adherence, while delivering goal-based automation. The DRILLOPS framework may generate activity plans automatically individual operations, whether they are monitored and/or controlled on the rig or in town. Automation may utilize data analysis and learning systems to assist and optimize tasks, such as, for example, setting ROP to drilling a stand. A preset menu of automatable drilling tasks may be rendered, and, using data analysis and models, a plan may be executed in a manner to achieve a specified goal, where, for example, measurements may be utilized for calibration. The DRILLOPS framework provides flexibility to modify and replan activities dynamically, for example, based on a live appraisal of various factors (e.g., equipment, personnel, and supplies). Well construction activities (e.g., tripping, drilling, cementing, etc.) may be continually monitored and dynamically updated using feedback from operational activities. The DRILLOPS framework may provide for various levels of automation based on planning and/or re-planning (e.g., via the DRILLPLAN framework), feedback, etc.

The PETREL framework may be part of the DELFI environment for utilization in geosciences and geoengineering, for example, to analyze subsurface data from exploration to production of fluid from a reservoir. The DELFI cognitive exploration and production (E&P) environment (SLB, Houston, Texas), referred to herein as the DELFI environment or DELFI framework, is a secure, cognitive, cloud-based collaborative environment that integrates data and workflows with digital technologies, such as artificial intelligence and machine learning.

The PETREL framework provides components that allow for optimization of various exploration, development and production operations. The PETREL framework includes seismic to simulation software components that may output information for use in increasing reservoir performance, for example, by improving asset team productivity. Through use of such a framework, various professionals (e.g., geophysicists, geologists, and reservoir engineers) may develop collaborative workflows and integrate operations to streamline processes (e.g., with respect to one or more geologic environments, etc.). Such a framework may be considered an application (e.g., executable using one or more devices) and may be considered a data-driven application (e.g., where data is input for purposes of modeling, simulating, etc.).

The TECHLOG framework may handle and process field and laboratory data for a variety of geologic environments (e.g., deepwater exploration, shale, etc.). The TECHLOG framework may structure wellbore data for analyses, planning, etc.

The PETROMOD framework provides petroleum systems modeling capabilities that may combine one or more of seismic, well, and geological information to model the evolution of a sedimentary basin. The PETROMOD framework may predict if, and how, a reservoir has been charged with hydrocarbons, including the source and timing of hydrocarbon generation, migration routes, quantities, and hydrocarbon type in the subsurface or at surface conditions.

The ECLIPSE framework provides a reservoir simulator (e.g., as a computational framework) with numerical solutions for fast and accurate prediction of dynamic behavior for various types of reservoirs and development schemes.

The INTERSECT framework provides a high-resolution reservoir simulator for simulation of detailed geological features and quantification of uncertainties, for example, by creating accurate production scenarios and, with the integration of precise models of the surface facilities and field operations, the INTERSECT framework may produce reliable results, which may be continuously updated by real-time data exchanges (e.g., from one or more types of data acquisition equipment in the field that may acquire data during one or more types of field operations, etc.). The INTERSECT framework may provide completion configurations for complex wells where such configurations may be built in the field, may provide detailed enhanced-oil-recovery (EOR) formulations where such formulations may be implemented in the field, may analyze application of steam injection and other thermal EOR techniques for implementation in the field, advanced production controls in terms of reservoir coupling and flexible field management, and flexibility to script customized solutions for improved modeling and field management control. The INTERSECT framework, as with the other example frameworks, may be utilized as part of the DELFI environment, for example, for rapid simulation of multiple concurrent cases. For example, a workflow may utilize one or more of the DELFI environment on demand reservoir simulation features.

The aforementioned DELFI environment provides various features for workflows as to subsurface analysis, planning, construction and production, for example, as illustrated in the workspace framework 110. As shown in FIG. 1, outputs from the workspace framework 110 may be utilized for directing, controlling, etc., one or more processes in the geologic environment 150 and, feedback 160, may be received via one or more interfaces in one or more forms (e.g., acquired data as to operational conditions, equipment conditions, environment conditions, etc.).

As an example, a workflow may progress to a geology and geophysics (“G&G”) service provider, which may generate a well trajectory, which may involve execution of one or more G&G frameworks (e.g., consider the PETREL framework, etc.).

In the example of FIG. 1, the visualization features 123 may be implemented via the workspace framework 110, for example, to perform tasks as associated with one or more of subsurface regions, planning operations, constructing wells and/or surface fluid networks, and producing from a reservoir.

As an example, a visualization process may implement one or more of various features that may be suitable for one or more web applications. For example, a template may involve use of the JAVASCRIPT object notation format (JSON) and/or one or more other languages/formats. As an example, a framework may include one or more converters. For example, consider a JSON to PYTHON converter and/or a PYTHON to JSON converter. Such an approach may provide for compatibility of devices, frameworks, etc., with respect to one or more sets of instructions.

As an example, visualization features may provide for visualization of various earth models, properties, etc., in one or more dimensions. As an example, visualization features may provide for rendering of information in multiple dimensions, which may optionally include multiple resolution rendering. In such an example, information being rendered may be associated with one or more frameworks and/or one or more data stores. As an example, visualization features may include one or more control features for control of equipment, which may include, for example, field equipment that may perform one or more field operations. As an example, a workflow may utilize one or more frameworks to generate information that may be utilized to control one or more types of field equipment (e.g., drilling equipment, wireline equipment, fracturing equipment, etc.).

As to a reservoir model that may be suitable for utilization by a simulator, consider acquisition of seismic data as acquired via reflection seismology, which finds use in geophysics, for example, to estimate properties of subsurface formations. As an example, reflection seismology may provide seismic data representing waves of elastic energy (e.g., as transmitted by P-waves and S-waves, in a frequency range of approximately 1 Hz to approximately 100 Hz). Seismic data may be processed and interpreted, for example, to understand better composition, fluid content, extent and geometry of subsurface rocks. Such interpretation results may be utilized to plan, simulate, perform, etc., one or more operations for production of fluid from a reservoir (e.g., reservoir rock, etc.).

As an example, a model may be a simulated version of a geologic environment. As an example, a simulator may include features for simulating physical phenomena in a geologic environment based at least in part on a model or models. A simulator, such as a reservoir simulator, may simulate fluid flow in a geologic environment based at least in part on a model that may be generated via a framework that receives seismic data. A simulator may be a computerized system (e.g., a computing system) that may execute instructions using one or more processors to solve a system of equations that describe physical phenomena subject to various constraints. In such an example, the system of equations may be spatially defined (e.g., numerically discretized) according to a spatial model that that includes layers of rock, geobodies, etc., that have corresponding positions that may be based on interpretation of seismic and/or other data. A spatial model may be a cell-based model where cells are defined by a grid (e.g., a mesh). A cell in a cell-based model may represent a physical area or volume in a geologic environment where the cell may be assigned physical properties (e.g., permeability, fluid properties, etc.) that may be germane to one or more physical phenomena (e.g., fluid volume, fluid flow, pressure, etc.). A reservoir simulation model may be a spatial model that may be cell-based.

While several simulators are illustrated in the example of FIG. 1, one or more other simulators may be utilized, additionally or alternatively. For example, consider the VISAGE geomechanics simulator (SLB, Houston Texas) or the PIPESIM network simulator (SLB, Houston Texas), etc. As an example, the KINTEX framework (SLB, Houston, Texas) may be utilized, for example, as a well services plug-in for the PETREL framework. The KINETIX framework may provide for multistage completion and stimulation design and production evaluation for conventional and unconventional reservoirs. As an example, the VISAGE geomechanics simulator and the KINETIX framework may be operative coupled (e.g., for running stimulation stresses processes, etc.).

As an example, a workflow may utilize one or more types of data for one or more processes (e.g., stratigraphic modeling, basin modeling, completion designs, drilling, production, injection, etc.). As an example, one or more tools may provide data that may be used in a workflow or workflows that may implement one or more frameworks.

In the example of FIG. 1, drilling may be performed in the geologic environment 150, for example, to access the reservoir 151, which may be accessed from land or offshore. In FIG. 1, the downhole equipment 154 may be, for example, part of a bottom hole assembly (BHA). The BHA may be used to drill a well. The downhole equipment 154 may communicate information to equipment at the surface, and may receive instructions and information from the equipment at the surface. During a well construction process, a variety of operations (such as cementing, wireline evaluation, testing, etc.) may be conducted. In such embodiments, data collected by tools and sensors and used for reasons such as reservoir characterization may be collected and transmitted.

A well may include a substantially horizontal portion (e.g., lateral portion) that may intersect with one or more fractures. For example, a well in a shale formation may pass through natural fractures, artificial fractures (e.g., hydraulic fractures), or a combination thereof. Such a well may be constructed using directional drilling techniques as described herein. However, these same techniques may be used in connection with other types of directional wells (such as slant wells, S-shaped wells, deep inclined wells, and others) and are not limited to horizontal wells.

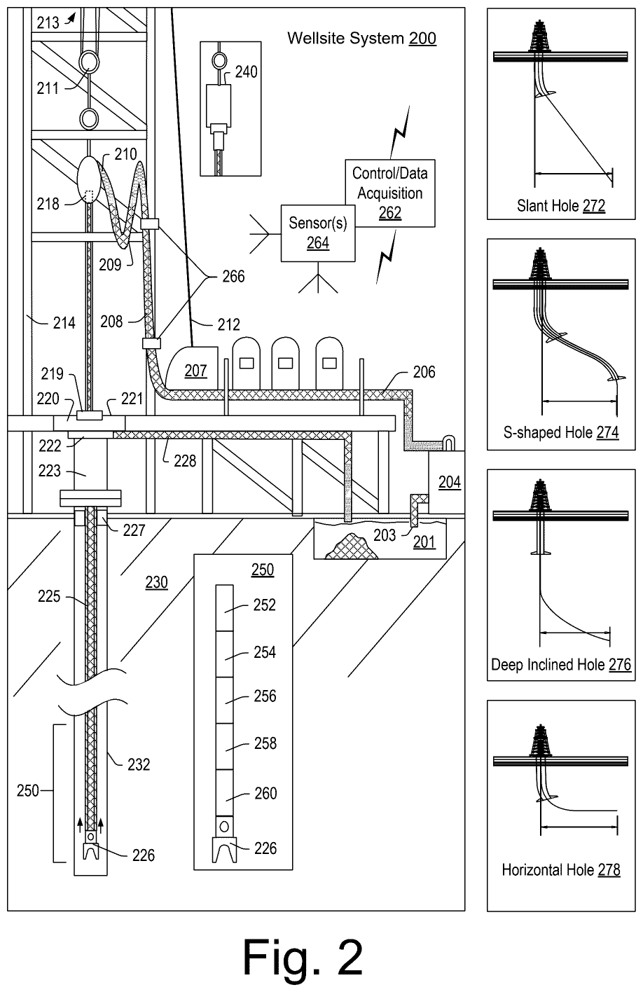

FIG. 2 shows an example of a wellsite system 200 (e.g., at a wellsite that may be onshore or offshore). As shown, the wellsite system 200 may include a mud tank 201 for holding mud and other material (e.g., where mud may be a drilling fluid), a suction line 203 that serves as an inlet to a mud pump 204 for pumping mud from the mud tank 201 such that mud flows to a vibrating hose 206, a drawworks 207 for winching drill line or drill lines 212, a standpipe 208 that receives mud from the vibrating hose 206, a kelly hose 209 that receives mud from the standpipe 208, a gooseneck or goosenecks 210, a traveling block 211, a crown block 213 for carrying the traveling block 211 via the drill line or drill lines 212, a derrick 214, a kelly 218 or a top drive 240, a kelly drive bushing 219, a rotary table 220, a drill floor 221, a bell nipple 222, one or more blowout preventors (BOPs) 223, a drillstring 225, a drill bit 226, a casing head 227 and a flow pipe 228 that carries mud and other material to, for example, the mud tank 201.

In the example system of FIG. 2, a borehole 232 is formed in subsurface formations 230 by rotary drilling; noting that various example embodiments may also use one or more directional drilling techniques, equipment, etc.

As shown in the example of FIG. 2, the drillstring 225 is suspended within the borehole 232 and has a drillstring assembly 250 that includes the drill bit 226 at its lower end. As an example, the drillstring assembly 250 may be a bottom hole assembly (BHA).

The wellsite system 200 may provide for operation of the drillstring 225 and other operations. As shown, the wellsite system 200 includes the traveling block 211 and the derrick 214 positioned over the borehole 232. As mentioned, the wellsite system 200 may include the rotary table 220 where the drillstring 225 pass through an opening in the rotary table 220.

As shown in the example of FIG. 2, the wellsite system 200 may include the kelly 218 and associated components, etc., or a top drive 240 and associated components. As to a kelly example, the kelly 218 may be a square or hexagonal metal/alloy bar with a hole drilled therein that serves as a mud flow path. The kelly 218 may be used to transmit rotary motion from the rotary table 220 via the kelly drive bushing 219 to the drillstring 225, while allowing the drillstring 225 to be lowered or raised during rotation. The kelly 218 may pass through the kelly drive bushing 219, which may be driven by the rotary table 220. As an example, the rotary table 220 may include a master bushing that operatively couples to the kelly drive bushing 219 such that rotation of the rotary table 220 may turn the kelly drive bushing 219 and hence the kelly 218. The kelly drive bushing 219 may include an inside profile matching an outside profile (e.g., square, hexagonal, etc.) of the kelly 218; however, with slightly larger dimensions so that the kelly 218 may freely move up and down inside the kelly drive bushing 219.

As to a top drive example, the top drive 240 may provide functions performed by a kelly and a rotary table. The top drive 240 may turn the drillstring 225. As an example, the top drive 240 may include one or more motors (e.g., electric and/or hydraulic) connected with appropriate gearing to a short section of pipe called a quill, that in turn may be screwed into a saver sub or the drillstring 225 itself. The top drive 240 may be suspended from the traveling block 211, so the rotary mechanism is free to travel up and down the derrick 214. As an example, a top drive 240 may allow for drilling to be performed with more joint stands than a kelly/rotary table approach.

In the example of FIG. 2, the mud tank 201 may hold mud, which may be one or more types of drilling fluids. As an example, a wellbore may be drilled to produce fluid, inject fluid or both (e.g., hydrocarbons, minerals, water, etc.).

In the example of FIG. 2, the drillstring 225 (e.g., including one or more downhole tools) may be composed of a series of pipes threadably connected together to form a long tube with the drill bit 226 at the lower end thereof. As the drillstring 225 is advanced into a wellbore for drilling, at some point in time prior to or coincident with drilling, the mud may be pumped by the pump 204 from the mud tank 201 (e.g., or other source) via the lines 206, 208 and 209 to a port of the kelly 218 or, for example, to a port of the top drive 240. The mud may then flow via a passage (e.g., or passages) in the drillstring 225 and out of ports located on the drill bit 226 (see, e.g., a directional arrow). As the mud exits the drillstring 225 via ports in the drill bit 226, it may then circulate upwardly through an annular region between an outer surface(s) of the drillstring 225 and surrounding wall(s) (e.g., open borehole, casing, etc.), as indicated by directional arrows. In such a manner, the mud lubricates the drill bit 226 and carries heat energy (e.g., frictional or other energy) and formation cuttings to the surface where the mud (e.g., and cuttings) may be returned to the mud tank 201, for example, for recirculation (e.g., with processing to remove cuttings, etc.).

The mud pumped by the pump 204 into the drillstring 225 may, after exiting the drillstring 225, form a mudcake that lines the wellbore which, among other functions, may reduce friction between the drillstring 225 and surrounding wall(s) (e.g., borehole, casing, etc.). A reduction in friction may facilitate advancing or retracting the drillstring 225. During a drilling operation, the entire drillstring 225 may be pulled from a wellbore and optionally replaced, for example, with a new or sharpened drill bit, a smaller diameter drillstring, etc. As mentioned, the act of pulling a drillstring out of a hole or replacing it in a hole is referred to as tripping. A trip may be referred to as an upward trip or an outward trip or as a downward trip or an inward trip depending on trip direction.

As an example, consider a downward trip where upon arrival of the drill bit 226 of the drillstring 225 at a bottom of a wellbore, pumping of the mud commences to lubricate the drill bit 226 for purposes of drilling to enlarge the wellbore. As mentioned, the mud may be pumped by the pump 204 into a passage of the drillstring 225 and, upon filling of the passage, the mud may be used as a transmission medium to transmit energy, for example, energy that may encode information as in mud-pulse telemetry.

As an example, mud-pulse telemetry equipment may include a downhole device configured to effect changes in pressure in the mud to create an acoustic wave or waves upon which information may modulated. In such an example, information from downhole equipment (e.g., one or more modules of the drillstring 225) may be transmitted uphole to an uphole device, which may relay such information to other equipment for processing, control, etc.

As an example, telemetry equipment may operate via transmission of energy via the drillstring 225 itself. For example, consider a signal generator that imparts coded energy signals to the drillstring 225 and repeaters that may receive such energy and repeat it to further transmit the coded energy signals (e.g., information, etc.).

As an example, the drillstring 225 may be fitted with telemetry equipment 252 that includes a rotatable drive shaft, a turbine impeller mechanically coupled to the drive shaft such that the mud may cause the turbine impeller to rotate, a modulator rotor mechanically coupled to the drive shaft such that rotation of the turbine impeller causes said modulator rotor to rotate, a modulator stator mounted adjacent to or proximate to the modulator rotor such that rotation of the modulator rotor relative to the modulator stator creates pressure pulses in the mud, and a controllable brake for selectively braking rotation of the modulator rotor to modulate pressure pulses. In such an example, an alternator may be coupled to the aforementioned drive shaft where the alternator includes at least one stator winding electrically coupled to a control circuit to selectively short the at least one stator winding to electromagnetically brake the alternator and thereby selectively brake rotation of the modulator rotor to modulate the pressure pulses in the mud.

In the example of FIG. 2, an uphole control and/or data acquisition system 262 may include circuitry to sense pressure pulses generated by telemetry equipment 252 and, for example, communicate sensed pressure pulses or information derived therefrom for process, control, etc.

The assembly 250 of the illustrated example includes a logging-while-drilling (LWD) module 254, a measurement-while-drilling (MWD) module 256, an optional module 258, a rotary-steerable system (RSS) and/or motor 260, and the drill bit 226. Such components or modules may be referred to as tools where a drillstring may include a plurality of tools.

As to an RSS, it involves technology utilized for directional drilling. Directional drilling involves drilling into the Earth to form a deviated bore such that the trajectory of the bore is not vertical; rather, the trajectory deviates from vertical along one or more portions of the bore. As an example, consider a target that is located at a lateral distance from a surface location where a rig may be stationed. In such an example, drilling may commence with a vertical portion and then deviate from vertical such that the bore is aimed at the target and, eventually, reaches the target. Directional drilling may be implemented where a target may be inaccessible from a vertical location at the surface of the Earth, where material exists in the Earth that may impede drilling or otherwise be detrimental (e.g., consider a salt dome, etc.), where a formation is laterally extensive (e.g., consider a relatively thin yet laterally extensive reservoir), where multiple bores are to be drilled from a single surface bore, where a relief well is desired, etc.

One approach to directional drilling involves a mud motor; however, a mud motor may present some challenges depending on factors such as rate of penetration (ROP), transferring weight to a bit (e.g., weight on bit, WOB) due to friction, etc. A mud motor may be a positive displacement motor (PDM) that operates to drive a bit (e.g., during directional drilling, etc.). A PDM operates as drilling fluid is pumped through it where the PDM converts hydraulic power of the drilling fluid into mechanical power to cause the bit to rotate.

As an example, a mud motor (e.g., PDM) may be operated in different modes, which may include a rotating mode and a sliding mode. A sliding mode involves drilling with a mud motor rotating the bit downhole without rotating the drillstring from the surface. Such an operation may be conducted when a BHA has been fitted with a bent sub or a bent housing mud motor, or both, for directional drilling. Sliding may be used in building and controlling or adjusting hole angle. In directional drilling, pointing of a bit may be accomplished through a bent sub, which may have a relatively small angle offset from the axis of a drillstring, and a measurement device to determine the direction of offset. Without turning the drillstring, the bit may be rotated with mud flow through the mud motor to drill in the direction it is pointed. With steerable motors, when a desired wellbore direction is attained, the entire drillstring may be rotated to drill straight rather than at an angle. By controlling the amount of hole drilled in the sliding mode versus the rotating mode, a wellbore trajectory may be controlled rather precisely.

As an example, a PDM may operate in a combined rotating mode where surface equipment is utilized to rotate a bit of a drillstring (e.g., a rotary table, a top drive, etc.) by rotating the entire drillstring and where drilling fluid is utilized to rotate the bit of the drillstring. In such an example, a surface RPM (SRPM) may be determined by use of the surface equipment and a downhole RPM of the mud motor may be determined using various factors related to flow of drilling fluid, mud motor type, etc. As an example, in the combined rotating mode, bit RPM may be determined or estimated as a sum of the SRPM and the mud motor RPM, assuming the SRPM and the mud motor RPM are in the same direction.

As an example, a PDM mud motor may operate in a so-called sliding mode, when the drillstring is not rotated from the surface. In such an example, a bit RPM may be determined or estimated based on the RPM of the mud motor.

An RSS may drill directionally where there is continuous rotation from surface equipment, which may alleviate the sliding of a steerable motor (e.g., a PDM). An RSS may be deployed when drilling directionally (e.g., deviated, horizontal, or extended-reach wells). An RSS may aim to minimize interaction with a borehole wall, which may help to preserve borehole quality. An RSS may aim to exert a relatively consistent side force akin to stabilizers that rotate with the drillstring or orient the bit in the desired direction while continuously rotating at the same number of rotations per minute as the drillstring.

The LWD module 254 may be housed in a suitable type of drill collar and may contain one or a plurality of selected types of logging tools. It will also be understood that more than one LWD and/or MWD module may be employed. Where the position of an LWD module is mentioned, as an example, it may refer to a module at the position of the LWD module 254, the MWD module 256, etc. An LWD module may include capabilities for measuring, processing, and storing information, as well as for communicating with the surface equipment. In the illustrated example, the LWD module 254 may include a seismic measuring device.

The MWD module 256 may be housed in a suitable type of drill collar and may contain one or more devices for measuring characteristics of the drillstring 225 and the drill bit 226. As an example, the MWD module 256 may include equipment for generating electrical power, for example, to power various components of the drillstring 225. As an example, the MWD module 256 may include the telemetry equipment 252, for example, where the turbine impeller may generate power by flow of the mud; it being understood that other power and/or battery systems may be employed for purposes of powering various components. As an example, the MWD module 256 may include one or more of the following types of measuring devices: a weight-on-bit measuring device, a torque measuring device, a vibration measuring device, a shock measuring device, a stick slip measuring device, a direction measuring device, and an inclination measuring device.

FIG. 2 also shows some examples of types of holes that may be drilled. For example, consider a slant hole 272, an S-shaped hole 274, a deep inclined hole 276 and a horizontal hole 278.

As an example, a drilling operation may include directional drilling where, for example, at least a portion of a well includes a curved axis. For example, consider a radius that defines curvature where an inclination with regard to the vertical may vary until reaching an angle between about 30 degrees and about 60 degrees or, for example, an angle to about 90 degrees or possibly greater than about 90 degrees.

As an example, a directional well may include several shapes where each of the shapes may aim to meet particular operational demands. As an example, a drilling process may be performed on the basis of information as and when it is relayed to a drilling engineer. As an example, inclination and/or direction may be modified based on information received during a drilling process.

As an example, deviation of a bore may be accomplished in part by use of a downhole motor and/or a turbine. As to a motor, for example, a drillstring may include a positive displacement motor (PDM).

As an example, a system may be a steerable system and include equipment to perform method such as geosteering. As mentioned, a steerable system may be or include an RSS. As an example, a steerable system may include a PDM or of a turbine on a lower part of a drillstring which, just above a drill bit, a bent sub may be mounted. As an example, above a PDM, MWD equipment that provides real time or near real time data of interest (e.g., inclination, direction, pressure, temperature, real weight on the drill bit, torque stress, etc.) and/or LWD equipment may be installed. As to the latter, LWD equipment may make it possible to send to the surface various types of data of interest, including for example, geological data (e.g., gamma ray log, resistivity, density and sonic logs, etc.).

The coupling of sensors providing information on the course of a well trajectory, in real time or near real time, with, for example, one or more logs characterizing the formations from a geological viewpoint, may allow for implementing a geosteering method. Such a method may include navigating a subsurface environment, for example, to follow a desired route to reach a desired target or targets.

As an example, a drillstring may include an azimuthal density neutron (ADN) tool for measuring density and porosity; a MWD tool for measuring inclination, azimuth and shocks; a compensated dual resistivity (CDR) tool for measuring resistivity and gamma ray related phenomena; one or more variable gauge stabilizers; one or more bend joints; and a geosteering tool, which may include a motor and optionally equipment for measuring and/or responding to one or more of inclination, resistivity and gamma ray related phenomena.

As an example, geosteering may include intentional directional control of a wellbore based on results of downhole geological logging measurements in a manner that aims to keep a directional wellbore within a desired region, zone (e.g., a pay zone), etc. As an example, geosteering may include directing a wellbore to keep the wellbore in a particular section of a reservoir, for example, to minimize gas and/or water breakthrough and, for example, to maximize economic production from a well that includes the wellbore.

Referring again to FIG. 2, the wellsite system 200 may include one or more sensors 264 that are operatively coupled to the control and/or data acquisition system 262. As an example, a sensor or sensors may be at surface locations. As an example, a sensor or sensors may be at downhole locations. As an example, a sensor or sensors may be at one or more remote locations that are not within a distance of the order of about one hundred meters from the wellsite system 200. As an example, a sensor or sensor may be at an offset wellsite where the wellsite system 200 and the offset wellsite are in a common field (e.g., oil and/or gas field).

As an example, one or more of the sensors 264 may be provided for tracking pipe, tracking movement of at least a portion of a drillstring, etc. For example, consider tracking for safety, position, velocity, acceleration, momentum, etc. As an example, tracking may be performed for one or more of a tripping operation, rate of penetration while drilling, non-productive time (NPT), invisible lost time (ILT), productive time, rig state, etc.

As to NPT, it may be utilized as a metric for one or more reasons, for example, consider a metric indicative of cost-effective and successful drilling operations. NPT may be caused by one or more of various reasons, which may include, for example, unpredictable circumstances, unexpected circumstances, one or more types of technical issues, etc. As to ILT, it may relate to one or more routine rig drilling operations and may be characterized as a difference between actual operational duration and a best practice target, which may be considered in various instances to be “invisible”, for example, if it does not appear in a regular morning report.

As an example, the system 200 may include one or more sensors 266 that may sense and/or transmit signals to a fluid conduit such as a drilling fluid conduit (e.g., a drilling mud conduit). For example, in the system 200, the one or more sensors 266 may be operatively coupled to portions of the standpipe 208 through which mud flows. As an example, a downhole tool may generate pulses that may travel through the mud and be sensed by one or more of the one or more sensors 266. In such an example, the downhole tool may include associated circuitry such as, for example, encoding circuitry that may encode signals, for example, to reduce demands as to transmission. As an example, circuitry at the surface may include decoding circuitry to decode encoded information transmitted at least in part via mud-pulse telemetry. As an example, circuitry at the surface may include encoder circuitry and/or decoder circuitry and circuitry downhole may include encoder circuitry and/or decoder circuitry. As an example, the system 200 may include a transmitter that may generate signals that may be transmitted downhole via mud (e.g., drilling fluid) as a transmission medium.

As an example, one or more portions of a drillstring may become stuck. The term stuck may refer to one or more of varying degrees of inability to move or remove a drillstring from a bore. As an example, in a stuck condition, it might be possible to rotate pipe or lower it back into a bore or, for example, in a stuck condition, there may be an inability to move the drillstring axially in the bore, though some amount of rotation may be possible. As an example, in a stuck condition, there may be an inability to move at least a portion of the drillstring axially and rotationally.

As to the term “stuck pipe”, this may refer to a portion of a drillstring that cannot be rotated or moved axially. As an example, a condition referred to as “differential sticking” may be a condition whereby the drillstring cannot be moved (e.g., rotated or reciprocated) along the axis of the bore. Differential sticking may occur when high-contact forces caused by low reservoir pressures, high wellbore pressures, or both, are exerted over a sufficiently large area of the drillstring. Differential sticking may have time and financial cost.

As an example, a sticking force may be a product of the differential pressure between the wellbore and the reservoir and the area that the differential pressure is acting upon. This means that a relatively low differential pressure (delta p) applied over a large working area may be just as effective in sticking pipe as may a high differential pressure applied over a small area.

As an example, a condition referred to as “mechanical sticking” may be a condition where limiting or prevention of motion of the drillstring by a mechanism other than differential pressure sticking occurs. Mechanical sticking may be caused, for example, by one or more of junk in the hole, wellbore geometry anomalies, cement, keyseats or a buildup of cuttings in the annulus.

As explained, a wellsite system may include various types of equipment for handling fluid such as, for example, drilling fluid (e.g., mud). As explained, drilling fluid may provide one or more functions (e.g., lubrication, transport of cutting, etc.).

Drilling fluid may be composed of a number of liquid and/or gaseous fluids and mixtures of fluids and solids (e.g., as solid suspensions, mixtures and emulsions of liquids, gases and solids) as may be used in various operations to drill boreholes into the earth. Classifications of drilling fluids may utilize one or more types of classification schemes. For example, consider water-based mud (WBM), oil-based mud (OBM), nonaqueous-based mud (NQBM), gaseous-based mud (e.g., pneumatic, etc.) (GBM), etc.

As an example, drilling fluid may be lost to a formation and/or reservoir fluid may enter drilling fluid. Hence, one or more functions of drilling fluid may be compromised by changes to drilling fluid. For example, if density of drilling fluid is altered by introduction of reservoir fluid, the drilling fluid may diminish in its ability to transport cuttings to surface. As a consequence, cuttings may build up within an annulus between a drillstring and a borehole wall or cased wellbore, which may increase risk of sticking (e.g., stuck pipe). To address changes to drilling fluid, one or more actions may be taken, for example, consider adding one or more components to the drilling fluid, adding additional drilling fluid, etc.

As to lost circulation or circulation loss, these terms may refer to loss of drilling fluid to a formation, for example, caused when the hydrostatic head pressure of the column of drilling fluid exceeds the formation pressure. This loss of fluid may be loosely classified as seepage losses, partial losses, or catastrophic losses, each of which may be handled differently depending on the risk to equipment, materials, borehole quality, characteristics of drilling fluid, personnel, etc.

As to influx of formation fluid (e.g., reservoir fluid, etc.), it may include an event known as a kick. A kick may be defined as a flow of formation fluid into a bore during drilling operations. A kick may be physically caused by the pressure in the bore being less than that of the formation fluid, thus causing flow. This condition of lower bore pressure than formation pressure may be caused in various ways. For example, if mud weight is too low, then hydrostatic pressure exerted on a formation by the fluid column may be insufficient to hold the formation fluid in the formation. This may happen if the mud density is suddenly lightened or is not to specification to begin with, or if a drilled formation has a higher pressure than expected. This type of kick might be called an underbalanced kick. As another example, consider a kick that may occur if dynamic and transient fluid pressure effects (e.g., due to motion of the drillstring or casing), effectively lower the pressure in a bore below that of the formation. Such a type of kick may be referred to as an induced kick.

Additional phenomena that may occur during drilling operations include swab and surge. As to swab, it may involve a reduction in pressure in a bore by moving pipe, wireline tools or where rubber-cupped seals up the bore. If the pressure is reduced sufficiently, reservoir fluid may flow into the bore and towards surface. Swabbing tends to be detrimental in drilling operations as it may lead to kick and borewall stability problems. As to surge, consider an example where a drillstring is being tripped-out (e.g., pulled out of hole (POOH)) where upward movement of the drillstring causes friction between the drillstring and drilling fluid. In surge, pressure may decrease in a bore due to the surge effect; noting that the opposite effect may happen when a drillstring is tripping-in (e.g., running in hole (RIH)), as downward movement may cause a pressure increase (e.g., a swab effect).

As explained, a drillstring may include a mud motor that is rotationally driven by flow of drilling fluid. In such a mode of drilling, the characteristics of drilling fluid may impact mud motor performance. For example, density (e.g., mud weight) may impact how much energy the mud motor may deliver to a drill bit for a given drilling fluid flow rate.

As to a stuck pipe or risk of sticking event, as explained, one or more actions may be taken. For example, consider addition of acid as a remedial action to address the stuck pipe event or to reduce the risk of a sticking event. In such an example, a number of barrels of acid may be added to drilling fluid that is circulated downhole to an annular region between a drilling string and a bore wall in an effort to “dissolve” material that is causing sticking or a risk of sticking. While addition of acid is mentioned, it may be an action within a tiered series of actions that may be taken, where, for example, each action may have associated benefits and detriments. As to detriments, these may include NPT, ILT, cost, further remedial actions (e.g., impact of acid on one or more additives in drilling fluid), etc. Hence, where an event occurs or a risk of an event is heightened, in an effort to maintain adherence to a plan, one or more actions may be implemented in a strategic manner to resolve the event or otherwise reduce the risk.

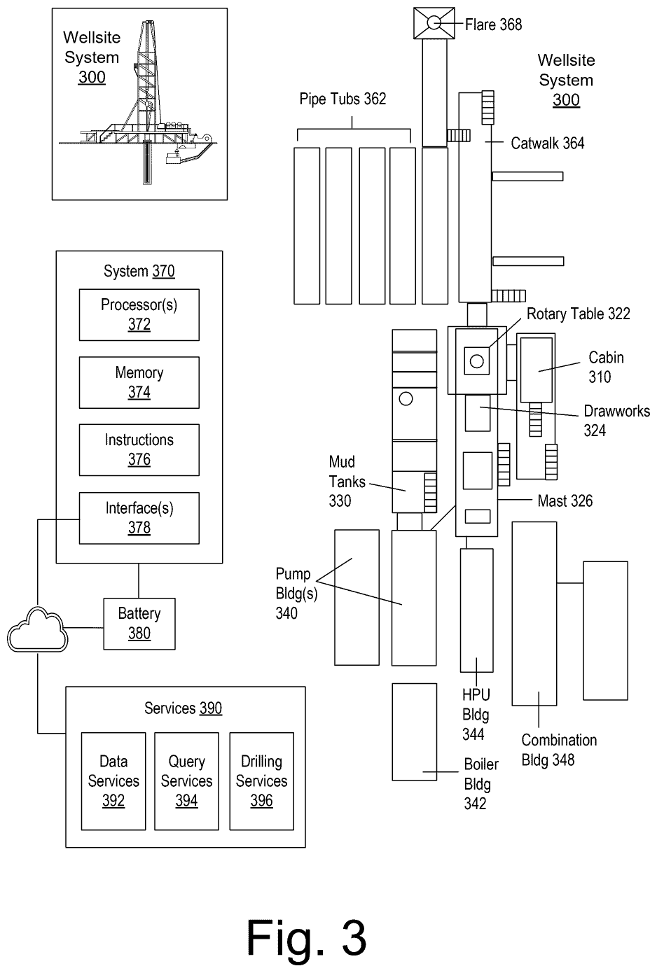

FIG. 3 shows an example of a wellsite system 300, specifically, FIG. 3 shows the wellsite system 300 in an approximate side view and an approximate plan view along with a block diagram of a system 370.

In the example of FIG. 3, the wellsite system 300 may include a cabin 310, a rotary table 322, drawworks 324, a mast 326 (e.g., optionally carrying a top drive, etc.), mud tanks 330 (e.g., with one or more pumps, one or more shakers, etc.), one or more pump buildings 340, a boiler building 342, an HPU building 344 (e.g., with a rig fuel tank, etc.), a combination building 348 (e.g., with one or more generators, etc.), pipe tubs 362, a catwalk 364, a flare 368, etc. Such equipment may include one or more associated functions and/or one or more associated operational risks, which may be risks as to time, resources, and/or humans.

As shown in the example of FIG. 3, the wellsite system 300 may include a system 370 that includes one or more processors 372, memory 374 operatively coupled to at least one of the one or more processors 372, instructions 376 that may be, for example, stored in the memory 374, and one or more interfaces 378. As an example, the system 370 may include one or more processor-readable media that include processor-executable instructions executable by at least one of the one or more processors 372 to cause the system 370 to control one or more aspects of the wellsite system 300. In such an example, the memory 374 may be or include the one or more processor-readable media where the processor-executable instructions may be or include instructions. As an example, a processor-readable medium may be a computer-readable storage medium that is not a signal and that is not a carrier wave.

FIG. 3 also shows a battery 380 that may be operatively coupled to the system 370, for example, to power the system 370. As an example, the battery 380 may be a back-up battery that operates when another power supply is unavailable for powering the system 370. As an example, the battery 380 may be operatively coupled to a network, which may be a cloud network. As an example, the battery 380 may include smart battery circuitry and may be operatively coupled to one or more pieces of equipment via a SMBus or other type of bus.

In the example of FIG. 3, services 390 are shown as being available, for example, via a cloud platform. Such services may include data services 392, query services 394 and drilling services 396. As an example, the services 390 may be part of a system such as the system 100 of FIG. 1 (e.g., consider planning services and/or operational services). As an example, the services 390 may include one or more services for directional drilling (e.g., consider a computational framework that may provide for one or more services that utilize real-time data to estimate one or more parameters, etc.).

As an example, the system 370 may be utilized to generate one or more rate of penetration drilling parameter values, which may, for example, be utilized to control one or more drilling operations.

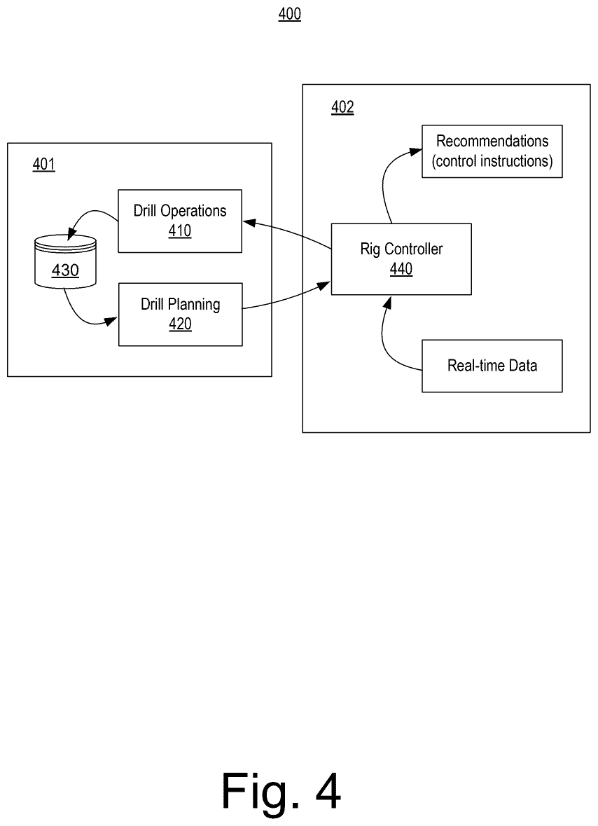

FIG. 4 shows an example of a system 400 that includes offsite equipment 401 (e.g., remote) and onsite equipment 402 (e.g., local). As shown, the offsite equipment 401 may include a drill operations framework 410, a drill planning framework 420 and a database 430 and the onsite equipment 402 may include a controller 440 that may receive real-time data and output recommendations such as control instructions to control onsite equipment. In such an example, the drill operations framework 410 may provide for steering sheets, execution parameters, etc., and the drill planning framework 420 may provide for evaluation of steering responses and statistics. As shown, the controller 440 may output information to the drill operations framework 410 and receive information from the drill planning framework 420. The system 400 may include plan generation features for real-time plan generation during drilling operations execution phase and/or plan generation during a planning phase. The system 400 may be utilized for one or more types of drilling (e.g., rotary, mud motor, RSS, ABSS, etc.). The system 400 may operate loops, which may include at least one real-time loop that provides for control of equipment to perform drilling operations.

A system such as the system 400 may utilize various functions and constraints for generation of plans, which may provide for single or multiple target aiming. As explained, a plan may be generated that aims to provide for drilling operations for a mutliwell structure. As explained, a plan may be a digital plan that may be utilized to instruct one or more controllers such as, for example, an autodriller controller, which may control one or more pieces of equipment (e.g., a drawworks, a top drive, one or more drilling fluid pumps, etc.). As an example, an autodriller may control energy delivered via one or more pieces of equipment to a drill bit where the drill bit crushes and/or cuts rock to extend a borehole. As an example, an autodriller may be controlled in an effort that aims to minimize or otherwise reduce mechanical specific energy (MSE) and to maximize or otherwise increase rate of penetration (ROP).

As an example, control of one or more field operations at a wellsite may be facilitated through use of a framework that may provide one or more actions for addressing an event, a risk of an event, etc. For example, consider a framework that may allow an engineer to interact with the framework via one or more graphical user interfaces (GUIs) and/or one or more other types of user interfaces (UIs) (e.g., microphone, QR code, etc.). In such an example, the engineer may enter information regarding an event such as a stuck pipe event, a lost circulation event, etc. In response, the framework may transform input received to a prompt or query that is submitted to one or more large language models (LLMs) that may be enriched with embeddings from historical drilling events and remediations applied. In response, the framework may generate output such as, for example, a ranked list of various historical events and remediations based on their effectiveness, which may be presented as proposals to the engineer, for example, as a textual summary of the remediation actions, rendered graphical controls that may be actuated to call for action in the field (e.g., by one or more pieces of equipment, by an autodriller, etc.), etc.

As an example, a framework may provide for machine-to-machine interactions, for example, to monitor, control, issue notifications, etc. As an example, a machine-to-machine approach may provide for natural language that accompanies machine instructions where, for example, natural language may be generated and translated into machine instructions and/or machine instructions may be generated and translated into natural language. In such examples, a user interface may be available for a human-in-the-loop (HITL), which may be for purposes of regulatory compliance, oversight, control, etc. In various instances, while substantial automation may be effectuated for control of field operations, regulations and/or practical concerns (e.g., as to equipment, a borehole, the environment, etc.) may demand a HITL.

As an example, a framework may utilize one or more generative artificial intelligence (AI) technologies. For example, a generative AI model may provide a form of AI that creates new text, images, video, audio, or other content largely based on training data utilized to train the generative AI model. A large language model (LLM) may be considered a form of generative AI that may focus on understanding text inputs (e.g., using natural language processing), which may be utilized to create output (e.g., human understandable text, etc.) based on a given input. LLMs may be viewed as a subset of generative AI for language-related tasks, which may be suitable for assisting humans, machines, humans and machines, etc.

A large language model (LLM) may be a type of language model notable for its ability to achieve general-purpose language understanding and generation (e.g., as a generative model, etc.). An LLM may acquire abilities by using relatively massive amounts of data to learn parameters (e.g., determine parameter values, etc.) during training. An LLM may be an artificial neural network or networks (e.g., consider a transformer, etc.) and may be trained and/or pre-trained using one or more types of learning (e.g., self-supervised learning, semi-supervised learning, unsupervised learning, etc.).

As to a transformer, it may include a block architecture where, for example, multiple transformer blocks may be arranged as and/or referred to as layers. For example, a transformer may include self-attention layers, feed-forward layers, and normalization layers, which may operate to process input to predict output at inference. As an example, layers may be stacked to make deeper transformers.

As an example, an autoregressive language model (e.g., AR LLM) may operate by taking input text and repeatedly predicting a next token or word. As an example, an LLM may be tuned, for example, for a particular domain. As an example, an LLM such as the Generative Pretrained Transformer (GPT) 3 (GPT-3) may be prompt-engineered. As an example, an LLM may acquire embodied knowledge about syntax, semantics and ontology inherent in human language corpora; noting that an LLM may also acquire inaccuracies and biases present in a corpora. As an example, a generative AI model or models may provide for encoding, decoding or encoding and decoding, for example, with an encoder and decoder architecture. As to encoders, consider implementation for tasks that may understand language, such as classification and sentiment analysis (e.g., consider Bidirectional Encoder Representations from Transformers (BERT) models, etc.). As to decoders, consider implementation for tasks such as generating language and/or other content (e.g., consider GPT-3 models, etc.). As to encoder-decoder, such an architecture may be implemented to understand and generate content. For example, consider translation and summarization (e.g., consider the T5 text-to-text transformer approach, etc.). As explained, a framework may provide for translating, for example, from machine language to machine language, from human language to human language, from machine language to human language, from human language to machine language, etc.

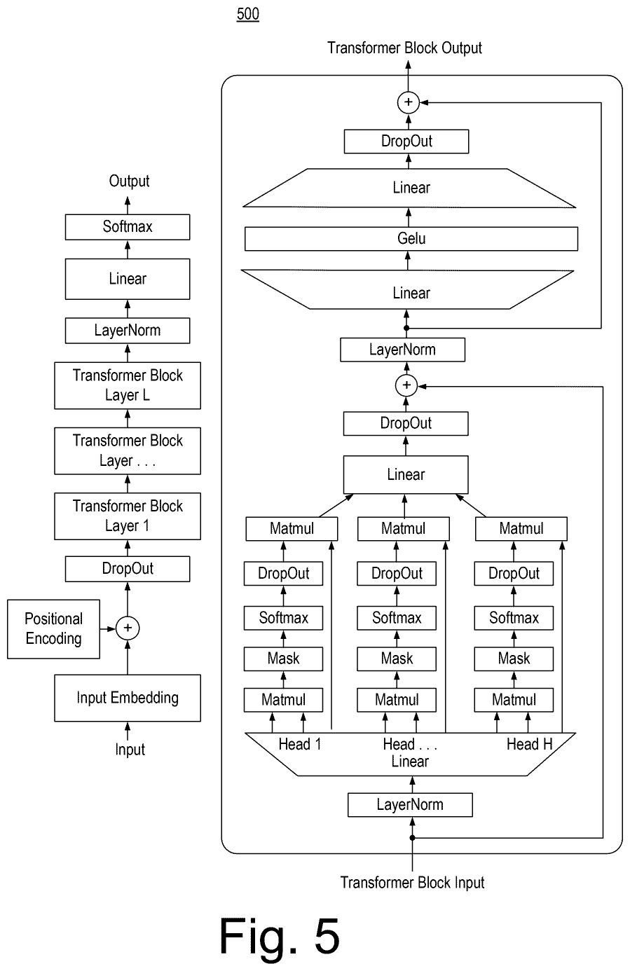

FIG. 5 shows an example architecture 500 of a GPT; noting that one or more features of the architecture 500 may be utilized in an LLM and/or other generative AI suitable for use within a framework. As explained, generative AI may utilize transformer blocks, where each transformer block may include various components. As an example, a foundation GPT model may be further adapted to produce more targeted systems directed to specific tasks and/or subject-matter domains. Techniques for such adaptation may include additional fine-tuning (e.g., beyond tuning of a foundation model, etc.), certain forms of prompt engineering, etc. As an example, an LLM may be a chatbot type of LLM. For example, consider the OpenAI ChatGPT LLM, which is an online chat interface powered by an instruction-tuned language model trained in a similar fashion to InstructGPT. Other chatbots may include features of GPT-4 (OpenAI), Bard (e.g., LaMDA family of conversation-trained language models, PaLM, etc.) (Google, Mountain View, California), etc.

As an example, a LLM Meta AI (LLaMA) LLM may be utilized, which includes a transformer architecture; noting some architectural differences compared to GPT-3. For example, LLAMA utilizes the SwiGLU activation function rather than ReLU, uses rotary positional embeddings rather than absolute positional embedding, and uses root-mean-squared layer-normalization rather than standard layer-normalization. Further, there may be an increase in context length from 2K (Llama 1) tokens to 4K (Llama 2) tokens between.

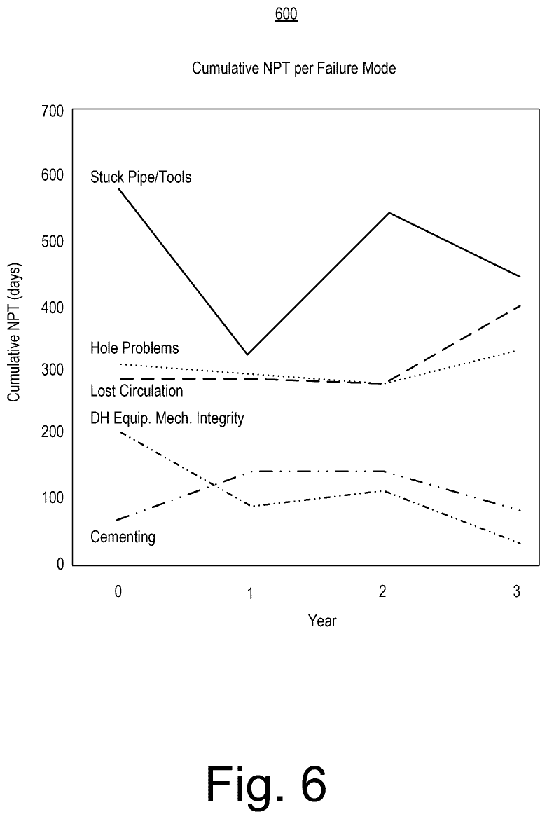

FIG. 6 shows an example of a plot 600 of cumulative non-productive time (NPT) per failure mode in field operations. Specifically, failure modes such as, for example, one or more of stuck pipe, stuck tools, lost circulation, downhole (DH) equipment mechanical integrity, hole problems, and cementing may include and/or be associated with one or more types of events. As shown in the plot 600, stuck pipe and/or stuck tools may result, cumulatively, in hundreds of days of NPT. NPT may be for time, noting that resources, energy, emissions, risks, etc., may also be associated with one or more failure modes. For example, a failure mode may result in an increase in carbon emissions (e.g., greenhouse gas emissions), consumption of fuel, risk to humans, risk to borehole integrity, etc. While NPT are shown in the plot 600, as mentioned, ILT may be tracked. As an example, a framework may provide for assessments with respect to NPT and/or ILT, which may provide for improved control of field operations.

As an example, during field operations, one or more individuals may enter a description of an event, and then, describe one or more remedial and/or containment options that may be taken and/or that are being taken. For example, consider a daily drilling report that may include one or more descriptions as to one or more events, risks of events, etc.

As an example, a daily drilling report (DDR) may include one or more of: the name of the well; the location of the well by latitude and longitude; the water depth at the well; the drilled depth; the work carried out; the lithology of formations penetrated; details of indication(s) of hydrocarbons; a summary of material used; drilling fluid losses; sticking (e.g., stuck pipe, stuck tool, etc.); a leak off test summary; the geometry of a wellbore; results of surveys made in a wellbore; and estimated daily and cumulative well costs. While various inputs may involve some human-machine interface (HMI) interaction, as explained, a framework may provide for machine-to-machine interactions (e.g., via one or more machine-machine interfaces (MMIs)).

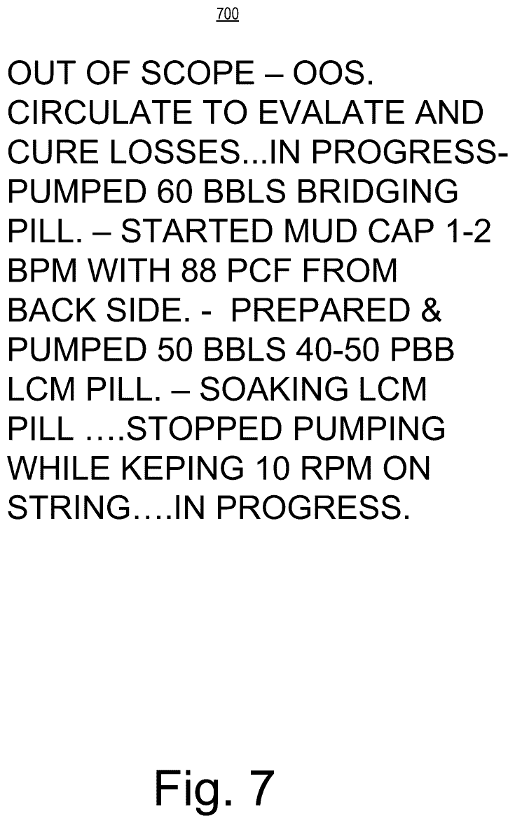

FIG. 7 shows an example of a portion of a DDR 700 that includes descriptions of an out of scope (OOS) issue where various actions are described as to addressing the OOS issue. For example, consider circulating, pumping materials, etc., which may occur with or without rotation of a drillstring and/or other tool string. As an example, descriptions may include physical descriptions as to one or more of volumetric rates, volumes, types of pills, types of actions, etc. As an example, one or more of such descriptions may be entered via an HMI and/or an MMI. In various instances, where an HMI is utilized, it may be in a relatively harsh environment, which may be harsh due to noise, equipment, environmental conditions, etc. In various instances, a human may be wearing PPE, which may make entries more challenging. For example, considering using a keyboard with PPE gloves on and/or while keeping an eye on equipment, people, material, etc. In various instances, typographical issues may arise, which may be handled by one or more features of a framework (e.g., in an automated, semi-automated, etc., manner).

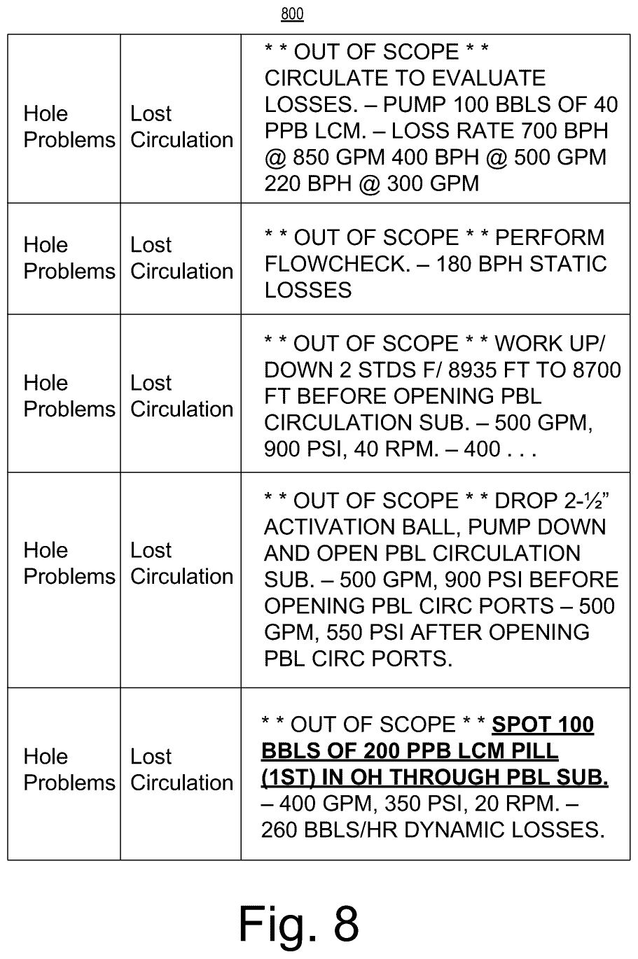

FIG. 8 shows an example of a portion or portions of a DDR or DDRs 800 as labeled with respect to hole problems, particularly, loss of circulation (e.g., lost circulation or circulation loss). As shown, various actions may be described. In the example of FIG. 8, the descriptions may include descriptions for characteristics of a lost circulation event (e.g., consider a severity between approximately 180 bbl/h and 260 bbl/h), followed by remediation actions (e.g., “SPOT 100 barrels of 200 PPB LCM pill (1^{ST}) in OH through PBL sub.”). As an example, a framework may provide for utilizing such data as to an event and one or more actions to address occurrence of such an event at the same wellsite and/or at one or more other wellsites.

As each well and associated operations may have some characteristics that are distinct from one or more other wells and their associated operations, it may take a team (e.g., a new team, a work shift team, etc.) some time to become familiar with a well and/or a section of a well and how to control associated operations, particularly when faced with an event or a risk of an event. For example, a learning curve for a team may take around three to four occurrences of an event for the team to learn the most effective way to manage that type of event or risk thereof. Such learning may be impacted, however, by personnel turnover. For example, consider turnover due to shifts, transfers, etc., of one or more people on a team. Further, various entities may tend to have organizational silos where learning that occurs in one silo is not spread to one or more other silos, which may prevent lessons learned in a specific operational context to be transferred for future application.

The amount of standard operating procedures (SOPs), local practices, success stories in addressing events, etc., tends to be quite extensive (e.g., thousands of instances, which may be documented in one or more knowledge bases, scientific publications, regulatory reports, etc.). Such data, or a portion thereof, may be accessed for purposes of training one or more models of a framework such that the framework may effectively shorten the learning curve to reduce NPT impact; noting that, based on the data shown in the plot 600 of FIG. 6 and elsewhere, NPT duration at the beginning of the learning curve for a human team tends to be nearly double the NPT duration at the end of the learning curve. As an example, a framework may be operable to reduce NPT at the onset of field operations and, for example, may continue to reduce NPT, which may be reduced in a more effective manner as field operations continue as, for example, the framework may provide for one or more actions early on for an event whereby such one or more actions may suitably address occurrence and/or risk of such an event at a later time. For example, a framework may provide for one or more actions that are fit for a wellsite, given available resources (e.g., material, equipment, personnel, etc.), where individuals of one or more teams (e.g., due to shifts, transfers, etc.) may more readily understand characteristics of events and solutions thereto, which, in turn, may reduce NPT and/or one or more other metrics (e.g., emissions, fuel usage, risks, etc.).

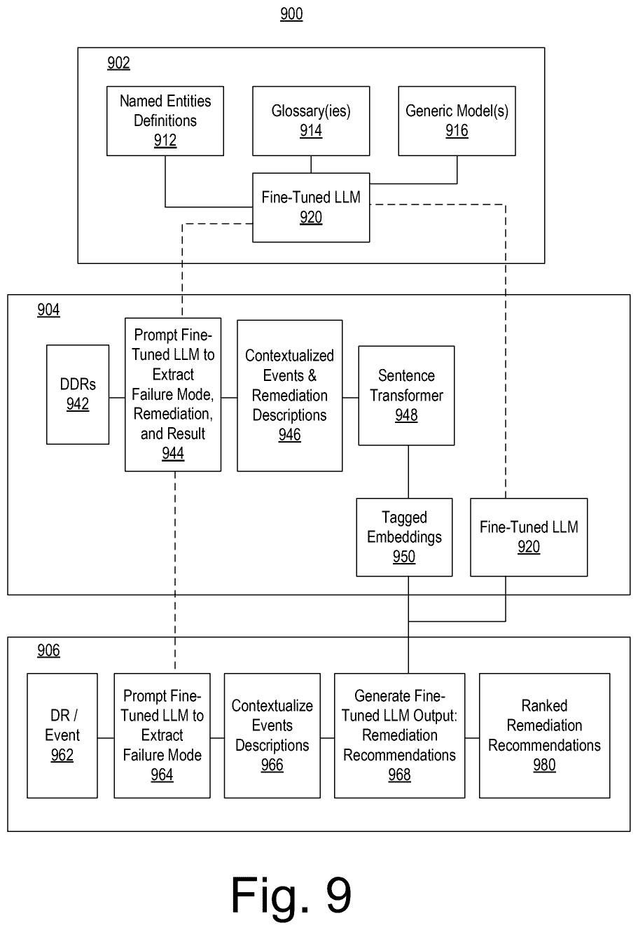

FIG. 9 shows an example of a system 900 that includes various features 902, 904, and 906. As shown, the features 902 may include features for generating a fine-tuned LLM 920, for example, using named entities definitions 912, one or more glossaries 914 (e.g., SLB Energy Glossary, etc.), and one or more generic models 916 (e.g., one or more generic LLMs). As to the features 904, these may provide for processing DDRs 942 where the fine-tuned LLM 920 may be prompted to extract failure modes, remediations and results 944. In such an example, the fine-tuned LLM 920 may output contextualized events and remediation descriptions 946, which may be processed, for example, using a sentence transformer 948 to generate tagged embeddings 950. As to the features 906, these may include an interface for receipt of a drilling report, an event and/or a risk of an event 962 (e.g., as entered via a UI, automatically generated, semi-automatically generated, etc.). As shown, the fine-tuned LLM 920 may be prompted 964 using the data received (e.g., data, descriptions, etc.) to extract one or more failure modes, which may be one or more contextualized events using descriptions 966. Given one or more descriptions, the fine-tuned LLM 920 may operate using the tagged embeddings 950 to generate output 968 that may include remediation recommendations, which may be associated with control instructions that may be implemented for control of field equipment, etc.

As shown in the example of FIG. 9, the remediation recommendations may be ranked using one or more criteria 980 such that a ranked listing and/or other presentation of one or more of the remediation recommendations may be reviewed for implementation and/or automatically implemented (e.g., consider receiving input via a UI that may select one of the remediation recommendations for implementation, automated implementation in view of ranking criteria, etc.). In such an example, the one or more criteria that may be utilized for ranking may include one or more criteria associated with a wellsite such as, for example, equipment, one or more controllers, materials, personnel, etc. For example, if a wellsite does not have an adequate supply of a particular material as specified in a remediation recommendation, then that may be a criterion that would reduce the rank of that remediation recommendation. As another example, if emissions are being monitored and near a limit, then a remediation recommendation that may push emissions beyond the limit may be reduced in rank. As an example, one or more criteria may be real-time, for example, as to supply of material, available energy, emissions levels, etc. As an example, a criterion may pertain to time, for example, NPT and/or other time. As an example, a ranking may depend on reduction in NPT.

As explained, a workflow may include fine tuning a generic LLM, for example, with a series of questions/answers to enrich the LLM with field operations (e.g., drilling, etc.) specific definitions. As an example, a workflow may involve translating or otherwise transforming descriptions in available DDRs into a suitable language such as, for example, the English language (e.g., optionally using a natural language processor, etc.). As an example, a workflow may include extracting events descriptions and/or remediations descriptions (e.g., remedial and/or containment actions descriptions, characteristics, etc.). As an example, a workflow may include performing a sentence embedding extraction. For example, a generic LLM may be trained (e.g., pre-trained) using a language such as the English language where a particular type of structure may be expected (e.g., sentences, etc.). In such an example, information from DDRs may be transformed into such a type of structure (e.g., sentences, etc.).

As an example, the system 900 may utilize the sentence transformer 948 to extract various key words (e.g., relevant terms, etc.) where such key words may be utilized in a tagging process to generate the tagged embeddings 950. As an example, a particular event description, which may be characterized as a failure mode, may be represented as a vector, for example, based on tagged embeddings generated through use of a sentence transformer. As an example, a workflow may utilize indexing where key words are indexed for purposes of finding one or more similar descriptions (e.g., DDRs, etc.) within a fine-tuned LLM. As an example, a workflow may include transforming a description of an event (see, e.g., the DR/event block 962) into a vector such that the vector may be utilized to effectively perform a search of other vectors to identify one or more similar events, which, as explained, may have associated remedial actions (remediations) that led to successful results. While various examples focus on successful results, a system may provide for generating output as to unsuccessful results, which may, for example, be utilized as part of a warning technique to warn an operator (e.g., operational team) as to actions that are unlikely to provide a successful result. As an example, a system (e.g., a framework, etc.) may provide for generation of permitted actions and unpermitted actions, which, as explained, may be utilized for control of field equipment. In such an approach, a level of automated control may be implemented with safeguards, for example, consider blocking implementation of unpermitted actions, which may be or include individual actions, a series of actions, parallel actions, etc. As an example, a system may be or include a controller.

As explained, the system 900 may utilize a vector-based approach where historical data (e.g., DDRs 942) are transformed into vectors using a fine-tuned LLM where a description may be transformed into a vector using the fine-tuned LLM where that vector may be utilized to identify one or more relevant historical events in the historical data, as transformed to vectors. As the historical data may be processed for remedial actions and results, these remedial actions and results may be returned for consideration in addressing an event or risk of an event associated with the description, which may be a fresh description (e.g., minutes old) as to one or more physical phenomena that are occurring at a wellsite (e.g., during ongoing field operations, etc.). As explained, such an approach may provide for resolving an event in a relatively rapid manner such that NPT and/or one or more other metrics may be suitably managed (e.g., energy, materials, emissions, etc.).

As explained, a workflow may include fine tuning a LLM with well construction drilling definitions. For example, general LLMs may be trained on publicly available information, and when prompted with specific drilling information containing un-known definitions such as “LCM”, or “HIVIS PILL”, the model may not be able to properly understand the context of the query. As such, fine tuning may include providing a general (e.g., generic) LLM with a set of question and answers in order for the LLM to be tuned with the new information. Some examples of questions and answers appear below in Table 1.

TABLE 1
Some Examples of Questions and Answers

| Query | Answer |
|---|---|
| What is LCM? | Solid material intentionally introduced |
| | into a mud system to reduce and |
| | eventually prevent the flow of drilling |
| | fluid into a weak, fractured or vugular |
| | formation. This material is generally |
| | fibrous or plate-like in nature, as |
| | suppliers attempt to design slurries that |
| | will efficiently bridge over and seal loss |
| | zones. In addition, popular lost |
| | circulation materials are low-cost waste |
| | products from the food processing or |
| | chemical manufacturing industries. |
| | Examples of lost circulation material |
| | include ground peanut shells, mica, |
| | cellophane, walnut shells, calcium |
| | carbonate, plant fibers, cottonseed |
| | hulls, ground rubber, and polymeric |
| | materials. |
| What is ABCD-1234 | ABCD-1234 is an Oil producer well |
| | drilled in 2017 for the BigOil Operator. |

As shown in Table 1, various specialized terms may be introduced, which may pertain to one or more particular organizations. As an example, a fine-tuned LLM may be fine-tuned to a particular organization or a number of organizations. As an example, a framework may provide for automatically selecting a fine-tuned LLM based on a preliminary search of language. For example, where a DDR includes terminology indicative of a particular organization, then a framework may select a fine-tuned LLM associated with that particular organization (e.g., fine-tuned using that terminology). As explained, standard operating procedures (SOPs) may be implemented in the field where, for example, SOPs may differ and/or be the same for one or more organizations. As SOPs may be part of remediation efforts and/or event detection, a fine-tuned LLM may be SOP specific.

As an example, a framework may operate using one or more sources of information, which may include privately available definitions sources, for example, from one or more drilling reporting systems and/or one or more oil and gas specific glossaries. As explained, a generic LLM may be tuned to be able to understand better a drilling domain language and/or one or more field operations domain languages.

As to drilling events summarization, consider DDRs that include incremental information about how an event unfolded, and how an operational team handled the event. In various instances, it may be challenging to look at historical data, and identify what happened, and what remedial action or actions were used and which one or ones were successful. As explained, a fine-tuned LLM may provide for processing of historical data (e.g., DDRs, etc.) such that it may utilize such knowledge in real-time (e.g., or near real-time) to generate output (e.g., remediation recommendations) using one or more descriptions for a well that is currently being drilled. As explained, a fine-tuned LLM may be utilized to summarize concatenated descriptions of an event. As explained, a fine-tuned LLM may be prompted to extract a failure mode, remedial actions and results using descriptions as input.
As an example of descriptions, consider the following text: CIRCULATE OUT ACID SOLUTION.—CLOSE blowout preventer CIRCULATE THROUGH CHOKE MANIFOLD IN CONTROL MANNER AS REQUIRED.—DUMP 280 barrel CONTAMINATED MUD & ACID . . . \npick up & make up 4 11/16″ OVERSHOT ASSY.—4 11/16″ LIP GUIDE—4 11/16″ BOWL (DRESS W/3⅛″SPIRAL GRAPPLE, MILL CONTROL & PACKER)—2 times 4 11/16″ EXTENSION—TOP SUB-PUMP OUT SUB—times/O (3½″ IF Box-XT-39)—MONITOR WELL ON TRIP TANK . . . \nHOLD PRE-JOB SAFETY MEETING WITH ALL PERSONNEL INVOLVED IN ACID JOB . . . \nWORK ON STUCK PIPE. PICK UP THE STRING, CONFIRM STRING FREE . . . \nrig up SURFACE LINES+2 times FOSV+SIDE ENTRY SUB.—P/TEST SURFACE LINES UP TO 5000 pounds per square inch, OK . . . \npull out of hole 5⅞″ VORTEX bottom hole assembly from/12046′ TO 11380′ (40′ INSIDE 7″ LINER).—TIGHT SPOTS AT 11862′ & 11745′, CLEAR W/WORKING STRING.—TIGHT SPOT AT 11841′ CLEAR W/SOFT BACK REAM . . . \nrun in hole W/4 11/16″ OVERSHOT ASSY. ON 5½″ drillpipe ON GOING.—MONITOR WELL ON TRIP TANK . . . \nWORK ON FISHING OPERATION W/4 11/16″ OVERSHOT ASSY.—from: 37 gallons per minute; stand pipe pressure: 320 pounds per square inch.—APPLY SLACK OFF IN STAGES UP TO 5 KLBS AND TENSION UP TO 335 KLBS (40 KLBS OVERPULL). NO CLEAR INDICATION TO CATCH FISH & NO CHANGE ON STAND PIPE PRESSURE.—GO BACK TO TAG FISH AGAIN, OBSERVE GOING DOWN FREE, FISH DROPPED DOWN.—run in hole FREE UP TO 12,021′ WHERE ENCOUNTER RESTRICTION.—CONT. run in hole OBSERVED 5 KLBS DRAG TO 12,148′ (END OF 4 11/16″ OVERSHOT AASY @ HOLE BOTTOM 12,360 FT). PUMP @ 37 gallons per minute, PRESSURE INCREASE UP TO 420 pounds per square inch.—WORK 4 11/16′ OVERSHOT ASSY ON BOTTOM WITH SLACK OFF 6 KLBS AND TENSION UP 335 KLBS.—OBSERVE PRESSURE INCREASE WITH 26 gallons per minute, stand pipe pressure: 410 pounds per square inch. BLEED OFF PRESSURE.—CHECK STRING FREE & PUMP @ 3 SPM, stand pipe pressure: 440 pounds per square inch. FISH ENGAGED.—PRESSURIZE UP TO 1000 pounds per square inch AS PER WL PROCEDURE TO CONFIRM ENGAGEMENT OF FISH, OK.—MONITOR THE MUD RETURNS AT TRIP TANKS WHILE CIRCULATING. SURVEY METER 0 MREM/hours, INTEGRITY OF THE RA SOURCES, OK . . . \npull out of hole 4 11/16″ OVERESHOT ASSY WITH CONTROL SPEED FROM BOTTOM TO 11210′ (END OF 4 11/16′ OVERSHOT ASSY).—MONITOR WELL ON TRIP TANK & TRIP SHEET.—STRING COMING OUT WET . . . \nWASH AND REAM DOWN IN OPEN HOLE FROM FROM 11420′ TO BOTTOM AT 12360′.—from: 260 gallons per minute; stand pipe pressure: 1660 pounds per square inch—TDS rotations per min: 100 rotations per min; torque: 3.3-4K FT-LB.—REAM & BACKREAM TWO TIMES ACROSS STUCK INTERVAL 1750′-12050′.—PERFORM STICK TEST EVERY STAND BEFORE CONNECTION. DEPTH 1 MIN 2 MIN 3 MIN torque: 11488′ 6.7K 6.8K 6.8K FT-LB 11502′ 6.7K 6.8K 7.0K FT-LB 11677′ 6.8K 7.2K 7.2K FT-LB 11771′ 6.7K 6.8K 6.8K FT-LB 11864′ 6.7K 7.1K 9.6K FT-LB 11958′ 6.7K 6.9K 7.1K FT-LB 12053′ 7.0K 6.8K 7.0K FT-LB 12148′ 7.0K 6.9K 7.0K FT-LB 12241′ 6.2K 7.3K 7.1K FT-LB 12337′ 6.9K 6.8K 7.0K FT-LB. \nFLUSH SURFACE LINES.—FLUSH CHOKE MANIFOLD, CHOKE MANIFOLD . . . \nWORK ON STUCK STRING AT 11840 FT IN BOTH DIRECTION.—JARRING UP AND TENSION UP TO 500K LB (210K LB OVERPULL).—JARRING DOWN AND RIGHT HAND TORQUE 12K FT-LB & SET DOWN ALL STRING WEIGHT.—NO SUCCESS.—MEANWHILE rig up CEMENT UNIT AND SURFACE LINES FOR ACID JOB. P/to SURFACE LINES UP TO 5000 pounds per square inch. OK . . . \nWORK STUCK PIPE & GOT FREE.—ALLOW 30 MIN FOR THE ACID TO REACT BEFORE WORKING THE PIPE.—EVERY 30 MINS PUMP 5 barrel FRESH ACID TO FORMATION. ** END OF THE ACID JOB OBSERVE 30 barrel LOSS. TOP UP ANNULUS, LEVEL STATIC . . . \npull out of hole 5⅞″ CLEAN OUT bottom hole assembly from/11840′TO 11300′ (120′ INSIDE 7″ LINER).—OPEN HOLE IN GOOD CONDITION . . . \nWORK STUCK PIPE. SPOT 40 barrel 20% HCL AS FOLLOW: RIG PUMP; —PUMP 180 barrel 125 PCF MUD AHEAD.—PUMP 20 barrel 105 PCF MUD. SWITCH TO CEMENT UNIT; —PUMP 40 barrel ACID, 20% HCL.—PUMP 50 barrel 105 PCF MUD WITH BRIDGING MATERIAL AS SPACER BEHIND.—SWITCH TO RIG PUMP: B/O 2 times FOSV & SIDE ENTRY SUB.—DISPLACE 20% HCl ACID SOLUTION WITH TOTAL 139 barrel. KEEP 20 barrel ACID INSIDE THE STRING.—LEFT STRING IN COMPRESSION (S/O 50K LB) AND APPLY STRING TORQUE TO 9K FT-LB . . . \nWORK ON STUCK PIPE AT BOTTOM WITHOUT SUCCESS.—JARRING UP AND TENSION UP TO 520K LB (200-220K LB OVERPULL), NO SUCCESS.—JARRING DOWN AND APPLY MAXIMUM SLACK OFF WEIGHT AND TORQUE STRING WITH 9K FT-LB·FT.—DISPLACE 1.5 barrel ACID INTO OPEN HOLE EVERY 30 MIN . . . \nrun in hole W/4 11/16″ OVERSHOT ASSY. ON 4″ drillpipe STD from/11′ TO 3128′—MONITOR WELL ON TRIP TANK . . . \nrun in hole W/4 11/16″ OVERSHOT FISHING ASSY ON 5½″ times 4″ drillpipe STANDS FROM 3600′ TO 11395′.—MONITOR WELL ON TRIP TANK . . . \nmake up SURFACE LINES+2 times FOSV+SIDE ENTRY SUB . . . \npull out of hole 4 11/16″ OVERSHOT ASSY W/CONTROL SPEED FROM 1500′ TO 1000′.—MONITOR WELL ON TRIP TANK AND TRIP SHEET.—TRIP SPEED: 3 MIN SLIP TO SLIP.—WET PULL.—WL SURVEY METER 0 MREM/hours, INTEGRITY OF THE RA SOURCES, OK . . . \nCHANGE ELEVATOR TO 5½″ drillpipe . . . \nOBSERVE SUDDEN OVERPULL 25 KLBS AT 11832′ AND BECOME FREE IMMEDIATELY. PULL FREE ANOTHER 15′ TO 11817′. TO CONFIRM FREE PASS run in hole BACK ON ELEVATOR. OBSERVE 12 KLBS SLACK-OFF AT SAME POINT. WORK STRING AND PASS FREE. LOWER THE STRING AND GOT 12 KLBS SLACK-OFF AT 11835′. APPLY rotations per min FREE PASS BETWEEN 11840′-11800′ COUPLE OF TIMES. STOP ROTATION. run in hole ON ELEVATOR GOT 1184′ SLACK-OFF. WORK STRING, NO PROGRESS. BACKREAM-REAMDOWN from/11840′-11780′ WITH PUMPS ON. SMOOTH torque: +/−3.9 KLBS·FT, NO ISSUE. IN ORDER TO CLEAR BELOW 11840′ SET SLIPS 5′ ABOVE ROTARY AND PROCEED CONNECTION. AFTER CONNECTION OBSERVE STRING DIFFERENTIALLY STUCK.—INCLINATION AT STUCK POINT+/−49DEGREE . . . \nCIRCULATE & CONDITION MUD.—from: 260 gallons per minute; stand pipe pressure: 1660 pounds per square inch—REAM UP/DOWN: 60/100-120 rotations per min; torque: 3.3-4K FT-LB.—NO GAIN/NO LOSSES—RECORD PARAMETERS: pick up weight: 290K LB, S/O weight: 275K LB, TDS rotations per min: 5/13 rotations per min; torque: 3.5K FT-LB—mud weight IN-OUT: 107 PCF. \nBREAK SURFACE LINES . . . \nCIRCULATE AT 11395′ PRIOR TO OPEN HOLE. from: 200-160 gallons per minute; stand pipe pressure: 440 pounds per square inch—RECORD PARAMETERS: pick up weight: 280K LB, S/O weight: 271K LB, torque: 2.7K FT-LB @10 rotations per min . . . \npull out of hole AND LAYDOWN FISH LOGGING STRIG.—100% FISH RECOVERED.—TRACTOR TOOLS CAME OUT IN GOOD CONDITION.—REST LOOGING TOOLS RECOVERED CAME OUT IN GOOD CONDITION.—RADIOACTIVE SOURCES RECOVERED.—MONITOR WELL ON TRIP TANK.—WL SURVEY METER 0 MREM/hours, INTEGRITY OF THE RA SOURCES, OK . . . \nHOLD PRE-JOB SAFETY MEETING WITH ALL PERSONNEL INVOLVE IN ACID JOB . . . \nWORK ON STUCK PIPE AT BOTTOM WITHOUT SUCCESS.—JARRING UP AND TENSION UP TO 400K LB (100-110K LB OVERPULL), NO SUCCESS.—SLACK OFF 50K WEIGHT AND APPLY TORQUE UP TO 9 KLB·FT, NO SUCCESS.—MEANWHILE rig up CEMENT UNIT AND SURFACE LINES FOR ACID JOB . . . \nFLOW CHECK, WELL STATIC . . . \nACTIVATE ECRD (ELECTRONIC CONTROL RELEASE DEVICE).—RELEASED WIRE LINE CABLE FROM ROPE SOCKET. pull out of hole WIRE TO SURFACE.—rig down WIRE LINE SURFACE TOOLS.—MONITOR WELL ON TRIP TANK . . . \nHPJSM PRIOR TO make up FISHING ASSY . . . \nPUMP OUT ACID TO CASED HOLE.—RECIPROCATE THE STRING WITH ROTATION AND CONFIRM FREE PASS . . . \npull out of hole 4 11/16″ OVERSHOT ASSY W/CONTROL SPEED AT 1500′ ON GOING.—MONITOR WELL ON TRIP TANK AND TRIP SHEET.—TRIP SPEED: 3 MIN SLIP TO SLIP.—WET PULL.—WL SURVEY METER 0 MREM/hours, INTEGRITY OF THE RA SOURCES, OK . . . \nCIRCULATE & CONDITION MUD.—TOTAL GAS—1.1-2%, CO2—29%.—from: 260 gallons per minute; stand pipe pressure: 1550 pounds per square inch—NO GAIN/NO LOSSES—mud weight IN-OUT: 107 PCF. \nWORK WIRELINE STRING STUCK, NO SUCCESS.—MOVE CABLE DOWN AND TOOL WAS NOT MOVING.—PULLED TO MAXIMUM SAFE PULL (MSP) OF THE CABLE (13984 LBF) WITH NO SUCCESS.—TRACTOR DOWN, NO SUCCESS.—TRACTOR UP, NO SUCCESS.—HOLD THE TOOL UNDER TENSION, NO SUCCESS.—MONITOR WELL ON TRIP TANK.—PERFORM hydrogen sulfide DRILL, GOOD RESPONSE . . . \nSTRING STUCK AT 12046′ AFTER CONNECTION. WORK ON STUCK PIPE ON GOING.—APPLY TORQUE UP TO 9 KLB·FT, WORK STRING NO SUCCESS.—JARRING UP MULTIPLE TIMES, STRING NOT FREE.—R/B STD & make up SINGLE JOINT.—NO RESTRICTION ON CIRCULATION, DIFFERENTIAL STUCK.—JAR WORKING, NO ISSUE. ** BEFORE CONNECTION BACKREAM 1 SINGLE (TORQUE: 4.1-4.5 KLB·FT). RECORD SURVEY, SURVEY OUT OF ACCEPTABLE CRITERIA. REAM DOWN & BACKREAM 11′ (TORQUE: 4.0-4.3 KLB·FT). REPEAT SURVEY, OK. REAM DOWN 1 SINGLE (TORQUE: 3.9-4.2 KLB·FT) AND PROCEED CONNECTION . . . \nWORK ON STUCK PIPE. SPOT 100 barrel 20% HCL ACID PILL AS FOLLOW: RIG PUMP; —180 barrel OF 125 PCF WEIGHTED PILL—20 barrels OF 125 PCF HI VIS WEIGHTED PILL SWITCH TO CEMENT UNIT; —100 barrel 20% HCl+VDA ACID PILL. SWITCH TO RIG PUMP: B/O FOSV+SIDE ENTRY SUB—20 barrels OF 125 PCF HI VIS WEIGHTED PILL—30 barrels OF 105 PCF WITH BRIDGING MATERIAL 30 pounds per barrel—DISPLACE ACID WITH 99 barrel DRILL STRING WITH 105 PCF MUD.—SPOT 40 barrel 20% HCL VDA ACID IN THE OPEN HOLE, KEEPING 60 barrel INSIDE THE STRING . . . \nSPOT ON BOTTOM 50 barrel CASING GO PILL—from: 260 gallons per minute; stand pipe pressure: 1650 pounds per square inch.—REAM UP/DOW: 60/120 rotations per min; torque: 3.5K FT-LB . . . \nCIRCULATE OUT ACID SOLUTION.—CLOSE blowout preventer CIRCULATE THROUGH CHOKE MANIFOLD IN CONTROL MANNER AS REQUIRED.—DUMP 180 barrel CONTAMINATED MUD & ACID . . . \nCIRCULATE & CONDITION MUD.—TOTAL GAS—1.1-2%, CO2—29% . . . \npull out of hole 4 11/16″ OVERSHOT ASSY W/CONTROL SPEED FROM 1000′ TO SURFACE—MONITOR WELL ON TRIP TANK AND TRIP SHEET.—TRIP SPEED: 3 MIN SLIP TO SLIP.—WET PULL.—OVERSHOT CAME OUT WITH LOGGING FISH ENGAGED.—WL SURVEY METER 0 MREM/hours, INTEGRITY OF THE RA SOURCES, OK . . . \nSOAKING TIME: —ALLOW 30 MIN FOR THE ACID TO REACT BEFORE WORKING THE PIPE.—STRING SET DOWN 150K LB WEIGHT AND TORQUE 9K FT-LB.—COMPLETE 30 MIN SOAKING TIME DISPLACE 10 barrel OUT BIT TO REFRESH ACID IN openhole. ** END OF THE ACID JOB OBSERVE 20 barrel LOSS. TOP UP ANNULUS THROUGH TRIP TANK, LEVEL STATIC . . . \nWORK STUCK PIPE: SPOT 55 barrel 20% HCL AS FOLLOW: RIG PUMP; —PUMP 160 barrel 125 PCF MUD AHEAD.—PUMP 20 barrel HI VIS HEAVY MUD125 PCF MUD. SWITCH TO CEMENT UNIT; —PUMP 55 barrel ACID, 20% HCL.—PUMP 20 barrel HI VIS HEAVY MUD 125 PCF MUD BEHIND.—PUMP 30 barrel 107 PCF MUD WITH BRIDGING MATERIAL.—SWITCH TO RIG PUMP: B/O 2 times FOSV & SIDE ENTRY SUB.—DISPLACE 20% HCL ACID SOLUTION WITH TOTAL 118 barrel 107 PCF MUD.—SPOT 20 barrel OF HCL ACID IN THE OPEN HOLE & KEEP 35 barrel ACID INSIDE THE STRING . . . \nCIRCULATE & CONDITION MUD.—mud weight IN/OUT: 105 PCF. Checked D&meter tools, measure while drilling not working. \nCIRCULATE OUT ACID SOLUTION.—from: 210 gallons per minute, stand pipe pressure: 2480 pounds per square inch.—CLOSE blowout preventer LAST 200 barrel AND CIRCULATE THROUGH CHOKE MANIFOLD IN CONTROL MANNER . . . \nrun in hole IN OPEN HOLE 4 11/16 OVERSHOT FISHING ASSY TO TOP OF THE FISH @ 11716′.—from: 50 gallons per minute, stand pipe pressure: 320 pounds per square inch.—RECORD pick up weight: 284K LB & S/O: 275K LB . . . \nSOAKING TIME: —ALLOW 30 MIN FOR THE ACID TO REACT BEFORE WORKING THE PIPE.—STRING SET DOWN 50K LB WEIGHT AND TORQUE 9K FT-LB. COMPLETE 30 MIN SOAKING TIME DISPLACE 5 barrel OUT BIT TO REFRESH ACID IN openhole.

The foregoing text may be sequential in its generation and therefore may be related to time, measured depth, etc. As an example, one or more of time and measured depth may be utilized to associate text and/or strings of text with rigsite data, for example, to determine rig state, action timing (e.g., start, stop, duration, etc.), action conditions, confirmation of an action or actions, control instructions, etc. As shown, various acronyms may be utilized, specialized terms, numbers, etc. As an example, the term “barrel” may appear as “barrel” or “bbl” or in one or more other forms. As an example, shorthand terms may appear such as, for example, “/n”, which may be particular to an operational team, an organization, etc. In the foregoing text, the term “acid” appears, along with the term “HCL”, which may be hydrochloric acid (HCl). As an example, fine-tuning may be performed to fine-tune an LLM to handle text such as the foregoing example text.

As an example, the foregoing example text was utilized as input to a fine-tuned LLM where the fine-tuned LLM was able to extract the specific remedial actions that resulted in curing the event:

### Failure Mode: Stuck Pipe (Differential Sticking)

### Remedial Actions:

1. Switch to cement unit and pump 55 barrels of acid, 20% HCL.
2. Displace 20% HCL acid solution with total 118 barrels of 107 PCF mud.
3. Spot 20 barrels of HCL acid in the open hole and keep 35 barrels acid inside the string.
4. Circulate and condition mud. Mud weight in/out: 105 PCF.
5. Checked D&meter tools, measure while drilling not working.
Result: The stuck pipe was successfully removed and drilling operations resumed.

As indicated, the fine-tuned LLM was able to extract an event (stuck pipe), a reason for sticking or classification of sticking (differential sticking as a failure mode, etc.), a listing of remedial actions (e.g., remediations), and a result (stuck pipe was successfully removed) where “drilling operations resumed”. Such an approach may provide for linking descriptions and/or actions to time. In such an example, NPT and/or other times may be determined, which, for example, may be utilized for ranking, etc. As an example, the foregoing remedial actions may be compared to one or more SOPs, which may include one or more differential sticking SOPs. In such an approach, the fine-tuned LLM may generate output that may provide for assessing adherence to one or more SOPs and/or as to improvement to one or more SOPs (e.g., for a particular type of field operation, type of well, type of formation, type of drilling fluid, etc.).

As an example, a system that may extract specific remedial actions that resulted in curing an event may also provide for determining control instructions as may have been implemented for performance of one or more of the specific remedial actions. For example, consider accessing rigsite data that may pertain to certain equipment, particular control commands, etc. In such an example, time stamps may be utilized, noting that there may be some amount of time differential between time of recordation of an extracted specific remedial action (e.g., as in a report, etc.) and time of issuance and/or implementation of a control instruction (e.g., a command, a notification, etc.). As an example, a system may provide for isolation of instances of rigsite data that correspond to specific remedial actions as may be indicated in a report, etc. In such an example, a system may provide for checking one or more extracted remedial actions against rigsite data to confirm performance thereof and/or timing thereof (e.g., start, stop, duration, etc.). In such an example, rigsite data may provide for uncovering one or more rig states, circumstances, etc., that may be germane to performance of one or more extracted remedial actions. In such an approach, a system may add rigsite data in a contextual manner, which may also provide for generation of instructions as to action timings and/or action sequences (e.g., series, parallel, if-then, etc.). As explained, such types of instructions may provide for control of equipment to perform one or more types of field operations.

As explained with respect to the system 900 of FIG. 9, contextualized event descriptions and remedial descriptions (e.g., remediation descriptions) may be used to generate embeddings, which may allow a user of a drilling reporting system to rapidly find remedial actions that solved a similar problem on one or more historical wells (e.g., offset wells, etc.). As explained, a system may provide for association and/or translation of information, for example, in human readable form, machine readable form (e.g., processor executable form, etc.), etc.

As an example, a framework may provide for receipt of a description of an event or a risk of an event and may generate an output based on a successful remediation of that event and/or the risk of the event for a prior instance. Such a risk may be at an offset well that was drilled at least in part when the event or risk of the event occurred and was successfully remediated. As explained, a framework may generate output for more than a single successful remediation, which may be for a well being drilled, an already drilled well, etc. As an example, one or more DDRs for a well currently being drilled may be utilized by a system to improve performance of a fine-tuned LLM, which may be applied to that well or one or more other wells currently being drilled.

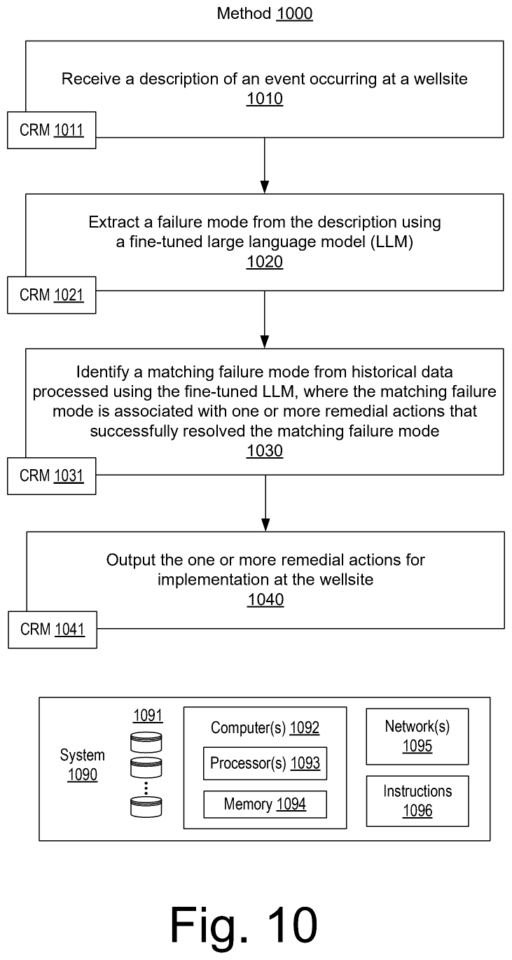

FIG. 10 shows an example of a method 1000 and an example of a system 1090. As shown, the method 1000 may include a reception block 1010 for receiving a description of an event occurring at a wellsite; an extraction block 1020 for extracting a failure mode from the description using a fine-tuned large language model (LLM); an identification block 1030 for identifying a matching failure mode from historical data processed using the fine-tuned LLM, where the matching failure mode is associated with one or more remedial actions that successfully resolved the matching failure mode; and an output block 1040 for outputting the one or more remedial actions for implementation at the wellsite. As an example, the method 1000 may include an implementation block for automatically, semi-automatically, etc., implementing at least one of the one or more remedial actions (e.g., remediations, etc.). As explained, output may include control instructions, may be associated with control instructions, may be amenable to translation to control instructions, etc. As explained, output may include safeguards, for example, specification of one or more actions not to be performed, one or more actions that may result in non-beneficial conditions, etc.

FIG. 10 also shows various computer-readable media (CRM) blocks 1011, 1021, 1031, and 1041. Such blocks may include instructions that are executable by one or more processors, which may be one or more processors of a computational framework, a system, a computer, etc. A computer-readable medium may be a computer-readable storage medium that is not a signal, not a carrier wave and that is non-transitory. For example, a computer-readable medium may be a physical memory component that may store information in a digital format.

In the example of FIG. 10, a system 1090 includes one or more information storage devices 1091, one or more computers 1092, one or more networks 1095 and instructions 1096. As to the one or more computers 1092, each computer may include one or more processors (e.g., or processing cores) 1093 and memory 1094 for storing the instructions 1096, for example, executable by at least one of the one or more processors. As an example, a computer may include one or more network interfaces (e.g., wired or wireless), one or more graphics cards, a display interface (e.g., wired or wireless), etc. The system 1090 may be specially configured to perform one or more portions of the method 1000 of FIG. 10.

As an example, a computational framework may include a solver, which may be implemented via executable instructions. For example, consider a computational framework that includes a processor and memory accessible to the processor where executable instructions may be stored in the memory and accessed for execution by the processor to cause the computational framework to perform one or more actions. Such a computational framework may include one or more interfaces for receipt of information and/or for output of information, which may include values of parameters, an instruction, etc. As an example, a computational framework may be part of a controller. As an example, a computational framework may be part of a system.

As an example, various systems, methods, etc., may implement one or more ML models. As to types of ML models, consider one or more of a support vector machine (SVM) model, a k-nearest neighbors (KNN) model, an ensemble classifier model, a neural network (NN) model, etc. As an example, a machine learning model may be a deep learning model (e.g., deep Boltzmann machine, deep belief network, convolutional neural network, stacked auto-encoder, etc.), an ensemble model (e.g., random forest, gradient boosting machine, bootstrapped aggregation, AdaBoost, stacked generalization, gradient boosted regression tree, etc.), a neural network model (e.g., radial basis function network, perceptron, back-propagation, Hopfield network, etc.), a regularization model (e.g., ridge regression, least absolute shrinkage and selection operator, elastic net, least angle regression), a rule system model (e.g., cubist, one rule, zero rule, repeated incremental pruning to produce error reduction), a regression model (e.g., linear regression, ordinary least squares regression, stepwise regression, multivariate adaptive regression splines, locally estimated scatterplot smoothing, logistic regression, etc.), a Bayesian model (e.g., naïve Bayes, average on-dependence estimators, Bayesian belief network, Gaussian naïve Bayes, multinomial naïve Bayes, Bayesian network), a decision tree model (e.g., classification and regression tree, iterative dichotomiser 3, C4.5, C5.0, chi-squared automatic interaction detection, decision stump, conditional decision tree, M5), a dimensionality reduction model (e.g., principal component analysis, partial least squares regression, Sammon mapping, multidimensional scaling, projection pursuit, principal component regression, partial least squares discriminant analysis, mixture discriminant analysis, quadratic discriminant analysis, regularized discriminant analysis, flexible discriminant analysis, linear discriminant analysis, etc.), an instance model (e.g., k-nearest neighbor, learning vector quantization, self-organizing map, locally weighted learning, etc.), a clustering model (e.g., k-means, k-medians, expectation maximization, hierarchical clustering, etc.), etc.

As an example, a system may utilize one or more recurrent neural networks (RNNs). One type of RNN is referred to as long short-term memory (LSTM), which may be a unit or component (e.g., of one or more units) that may be in a layer or layers. A LSTM component may be a type of artificial neural network (ANN) designed to recognize patterns in sequences of data, such as time series data. When provided with time series data, LSTMs take time and sequence into account such that an LSTM may include a temporal dimension. For example, consider utilization of one or more RNNs for processing temporal data from one or more sources, optionally in combination with spatial data. Such an approach may recognize temporal patterns, which may be utilized for making predictions (e.g., as to a pattern or patterns for future times, etc.).

As an example, the TENSORFLOW framework (Google LLC, Mountain View, California) may be implemented, which is an open-source software library for dataflow programming that includes a symbolic math library, which may be implemented for machine learning applications that may include neural networks. As an example, the CAFFE framework may be implemented, which is a DL framework developed by Berkeley AI Research (BAIR) (University of California, Berkeley, California). As another example, consider the SCIKIT platform (e.g., scikit-learn), which utilizes the PYTHON programming language. As an example, a framework such as the APOLLO AI framework may be utilized (APOLLO.AI GmbH, Germany). As mentioned, a framework such as the PYTORCH framework may be utilized.

As an example, a training method may include various actions that may operate on a dataset to train a ML model. As an example, a dataset may be split into training data and test data where test data may provide for evaluation. A method may include cross-validation of parameters and best parameters, which may be provided for model training.

The TENSORFLOW framework may run on multiple CPUs and GPUs (with optional CUDA (NVIDIA Corp., Santa Clara, California) and SYCL (The Khronos Group Inc., Beaverton, Oregon) extensions for general-purpose computing on graphics processing units (GPUS)). TENSORFLOW is available on 64-bit LINUX, MACOS (Apple Inc., Cupertino, California), WINDOWS (Microsoft Corp., Redmond, Washington), and mobile computing platforms including ANDROID (Google LLC, Mountain View, California) and IOS (Apple Inc.) operating system-based platforms.

TENSORFLOW computations may be expressed as stateful dataflow graphs; noting that the name TENSORFLOW derives from the operations that such neural networks perform on multidimensional data arrays. Such arrays may be referred to as “tensors”.

As an example, a method may include receiving a description of an event occurring at a wellsite; extracting a failure mode from the description using a fine-tuned large language model (LLM); identifying a matching failure mode from historical data processed using the fine-tuned LLM, where the matching failure mode is associated with one or more remedial actions that successfully resolved the matching failure mode; and outputting the one or more remedial actions for implementation at the wellsite. In such an example, the event may be a drilling fluid event and/or another type of event. As to a drilling fluid event it may be a loss in circulation event. As to a sticking event, it may be a differential sticking event and/or another type of sticking event. As an example, a failure mode may be an event and/or a reason for an event, where such an event and/or reason is present in historical data, for example, along with one or more remedial actions and an indication of success and/or failure for one or more of the one or more remedial actions in addressing the failure mode.

As an example, a method may include generating a fine-tuned LLM. In such an example, generating the fine-tuned LLM may include utilizing a series of specialized questions and answers. For example, consider a series of specialized questions and answers that may include field operations terms and definitions for the field operations terms. As an example, a brand (e.g., trademark) may be a term that may be associated with one or more specifics such as, for example, chemicals, etc. In such an example, one or more other brands may be possible substitutes. As an example, a fine-tuned LLM may provide for discerning brands, chemicals, etc. (e.g., within context of descriptions, etc.).

As an example, a method may include extracting the failure mode at least in part by generating a vector. In such an example, the method may include identifying a matching failure mode at least in part by comparing the vector to existing vectors where, for example, the existing vectors are generated using a fine-tuned LLM. For example, a fine-tuned LLM may extract information from a current description pertaining to an on-going issue at a wellsite (e.g., an event) and extract information from historical descriptions where a vector-based approach may be utilized in a matching process. As an example, existing vectors may be generated at least in part by applying a sentence transformer to output of a fine-tuned LLM and, for example, may be further generated using tagged embeddings based on output of the sentence transformer.

As an example, a fine-tuned LLM may include at least a portion of a generative pretrained transformer (GPT) architecture. As an example, a GPT architecture may be modified for one or more purposes.

As an example, historical data may include daily drilling reports (DDRs).

As an example, a method may include identifying multiple instances of a matching failure mode in historical data. In such an example, the method may include ranking the multiple instances according to one or more criteria and/or ranking the multiple instances based on closeness of matching.

As an example, a matching failure mode may be an exact match or a closest match. As explained, for one or more reasons, descriptions entered by one operational team may vary from descriptions entered by another operational team. As to such reasons, they may be due to organizational differences, personnel, material, brands, equipment, formation, location, regulation, etc.

As explained, a human may be challenged in finding a match between a current issue and past issues. As explained, a drilling event remediation framework may find one or more matches in a time frame that may expedite field operations (e.g., reduce NPT, etc.). For example, consider a time frame that is real-time or near real-time where a drilling report system may continuously assess descriptions for events, etc., and where a matching process may be implemented (e.g., as a background process) to continuously generate matches. In such an approach, where an event (e.g., an issue) arises, or a sufficiently high risk thereof, the framework may have one or more remedial actions ready for recommendation and/or implementation (e.g., automatically, semi-automatically, etc.).

As an example, equipment at a wellsite may be operable using one or more levels of automation. As an example, a drilling event remediation framework may report on a level of automation as implemented as to a historical action for remediation and/or as to a possible level of automation for an action for remediation, noting that some types of actions may be implemented automatically while others may demand some amount of involvement by operational personnel (e.g., acquiring material, etc.).

As an example, a system may include one or more processors; memory accessible to at least one of the one or more processors; processor-executable instructions stored in the memory and executable to instruct the system to: receive a description of an event occurring at a wellsite; extract a failure mode from the description using a fine-tuned large language model (LLM); identify a matching failure mode from historical data processed using the fine-tuned LLM, where the matching failure mode is associated with one or more remedial actions that successfully resolved the matching failure mode; and output the one or more remedial actions for implementation at the wellsite.

As an example, one or more computer-readable storage media may include processor-executable instructions to instruct a computing system to: receive a description of an event occurring at a wellsite; extract a failure mode from the description using a fine-tuned large language model (LLM); identify a matching failure mode from historical data processed using the fine-tuned LLM, where the matching failure mode is associated with one or more remedial actions that successfully resolved the matching failure mode; and output the one or more remedial actions for implementation at the wellsite.

As an example, a computer program product that may include computer-executable instructions to instruct a computing system to perform one or more methods such as one or more of the methods described herein (e.g., in part, in whole and/or in various combinations).

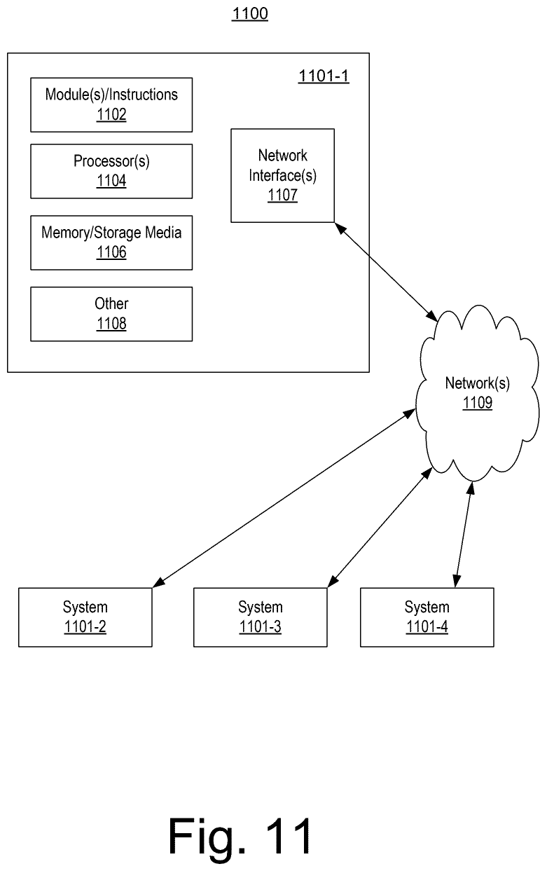

In some embodiments, a method or methods may be executed by a computing system. FIG. 11 shows an example of a system 1100 that may include one or more computing systems 1101-1, 1101-2, 1101-3 and 1101-4, which may be operatively coupled via one or more networks 1109, which may include wired and/or wireless networks. As shown, the system 1100 may include one or more other components 1108.

As an example, a system may include an individual computer system or an arrangement of distributed computer systems. In the example of FIG. 11, the computer system 1101-1 may include one or more modules 1102, which may be or include processor-executable instructions, for example, executable to perform various tasks (e.g., receiving information, requesting information, processing information, simulation, outputting information, etc.).

As an example, a module may be executed independently, or in coordination with, one or more processors 1104, which is (or are) operatively coupled to one or more storage media 1106 (e.g., via wire, wirelessly, etc.). As an example, one or more of the one or more processors 1104 may be operatively coupled to at least one of one or more network interface 1107. In such an example, the computer system 1101-1 may transmit and/or receive information, for example, via the one or more networks 1109 (e.g., consider one or more of the Internet, a private network, a cellular network, a satellite network, etc.). As shown, one or more other components 1108 may be included in the computer system 1101-1.

As an example, the computer system 1101-1 may receive from and/or transmit information to one or more other devices, which may be or include, for example, one or more of the computer systems 1101-2, etc. A device may be located in a physical location that differs from that of the computer system 1101-1. As an example, a location may be, for example, a processing facility location, a data center location (e.g., server farm, etc.), a rig location, a wellsite location, a downhole location, etc.

As an example, a processor may be or include a microprocessor, microcontroller, processor module or subsystem, programmable integrated circuit, programmable gate array, or another control or computing device.

As an example, the storage media 1106 may be implemented as one or more computer-readable or machine-readable storage media. As an example, storage may be distributed within and/or across multiple internal and/or external enclosures of a computing system and/or additional computing systems.

As an example, a storage medium or storage media may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLUERAY disks, or other types of optical storage, or other types of storage devices.

As an example, a storage medium or media may be located in a machine running machine-readable instructions, or located at a remote site from which machine-readable instructions may be downloaded over a network for execution.

As an example, various components of a system such as, for example, a computer system, may be implemented in hardware, software, or a combination of both hardware and software (e.g., including firmware), including one or more signal processing and/or application specific integrated circuits.

As an example, a system may include a processing apparatus that may be or include a general-purpose processors or application specific chips (e.g., or chipsets), such as ASICs, FPGAs, PLDs, or other appropriate devices.

As an example, a device may be a mobile device that includes one or more network interfaces for communication of information. For example, a mobile device may include a wireless network interface (e.g., operable via IEEE 802.11, ETSI GSM, BLUETOOTH, satellite, etc.). As an example, a mobile device may include components such as a main processor, memory, a display, display graphics circuitry (e.g., optionally including touch and gesture circuitry), a SIM slot, audio/video circuitry, motion processing circuitry (e.g., accelerometer, gyroscope), wireless LAN circuitry, smart card circuitry, transmitter circuitry, GPS circuitry, and a battery. As an example, a mobile device may be configured as a cell phone, a tablet, etc. As an example, a method may be implemented (e.g., wholly or in part) using a mobile device. As an example, a system may include one or more mobile devices.

As an example, a system may be a distributed environment, for example, a so-called “cloud” environment where various devices, components, etc. interact for purposes of data storage, communications, computing, etc. As an example, a device or a system may include one or more components for communication of information via one or more of the Internet (e.g., where communication occurs via one or more Internet protocols), a cellular network, a satellite network, etc. As an example, a method may be implemented in a distributed environment (e.g., wholly or in part as a cloud-based service).

As an example, information may be input from a display (e.g., consider a touchscreen), output to a display or both. As an example, information may be output to a projector, a laser device, a printer, etc. such that the information may be viewed. As an example, information may be output stereographically or holographically. As to a printer, consider a 2D or a 3D printer. As an example, a 3D printer may include one or more substances that may be output to construct a 3D object. For example, data may be provided to a 3D printer to construct a 3D representation of a subterranean formation. As an example, layers may be constructed in 3D (e.g., horizons, etc.), geobodies constructed in 3D, etc. As an example, holes, fractures, etc., may be constructed in 3D (e.g., as positive structures, as negative structures, etc.).

Although only a few examples have been described in detail above, those skilled in the art will readily appreciate that many modifications are possible in the examples. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures.

What is claimed is:

1. A method comprising:
receiving a description of an event occurring at a wellsite;
extracting a failure mode from the description using a fine-tuned large language model (LLM);
identifying a matching failure mode from historical data processed using the fine-tuned LLM, wherein the matching failure mode is associated with one or more remedial actions that successfully resolved the matching failure mode; and
outputting the one or more remedial actions for implementation at the wellsite.

2. The method of claim 1, wherein the event comprises a drilling fluid event.

3. The method of claim 2, wherein the drilling fluid event comprises a loss in circulation event.

4. The method of claim 1, wherein the event comprises a sticking event.

5. The method of claim 4, wherein the sticking event comprises a differential sticking event.

6. The method of claim 1, comprising generating the fine-tuned LLM.

7. The method of claim 6, wherein generating the fine-tuned LLM comprises utilizing a series of specialized questions and answers.

8. The method of claim 7, wherein the series of specialized questions and answers comprise field operations terms and definitions for the field operations terms.

9. The method of claim 1, wherein the extracting the failure mode comprises generating a vector.

10. The method of claim 9, wherein the identifying the matching failure mode comprises comparing the vector to existing vectors.

11. The method of claim 10, wherein the existing vectors are generated using the fine-tuned LLM.

12. The method of claim 11, wherein the existing vectors are generated by applying a sentence transformer to output of the fine-tuned LLM and further generated using tagged embeddings based on output of the sentence transformer.

13. The method of claim 1, wherein the fine-tuned LLM comprises at least a portion of a generative pretrained transformer (GPT) architecture.

14. The method of claim 1, wherein the historical data comprise daily drilling reports (DDRs).

15. The method of claim 1, comprising identifying multiple instances of the matching failure mode in the historical data.

16. The method of claim 15, comprising ranking the multiple instances according to one or more criteria.

17. The method of claim 15, comprising ranking the multiple instances based on closeness of matching.

18. The method of claim 1, wherein the matching failure mode comprises an exact match or a closest match.

19. A system comprising:
one or more processors;
memory accessible to at least one of the one or more processors;
processor-executable instructions stored in the memory and executable to instruct the system to:
receive a description of an event occurring at a wellsite;
extract a failure mode from the description using a fine-tuned large language model (LLM);
identify a matching failure mode from historical data processed using the fine-tuned LLM, wherein the matching failure mode is associated with one or more remedial actions that successfully resolved the matching failure mode; and
output the one or more remedial actions for implementation at the wellsite.

20. One or more computer-readable storage media comprising processor-executable instructions to instruct a computing system to:
receive a description of an event occurring at a wellsite;
extract a failure mode from the description using a fine-tuned large language model (LLM);
identify a matching failure mode from historical data processed using the fine-tuned LLM, wherein the matching failure mode is associated with one or more remedial actions that successfully resolved the matching failure mode; and
output the one or more remedial actions for implementation at the wellsite.
